(19) United States
(12) Patent Application Publication
(10) Pub. No.: US 2002/0181869 A1
(43) Pub. Date: Dec. 5, 2002

(54) Tunable dispersion compensator

(76) Inventor: Wenhua Lin, Pasadena, CA (US)

Correspondence Address: TRAVIS DODD, 2490 HEYNEMAN HOLLOW, FALLBROOK, CA, 92028, US

(21) Appl. No.: 09/872,473

(22) Filed: Jun. 1, 2001

(51) Int. Cl. G02B 6/26

(52) U.S. Cl. 385/37; 385/15; 385/27

(57) ABSTRACT

A tunable dispersion compensator is disclosed. The dispersion compensator includes an array waveguide grating having a plurality of array waveguides. A component is configured to receive portions of a light signal from the array waveguide grating and to combine the portions of the light signal into an output light signal having a dispersion profile. At least a portion of the array waveguides include an effective length tuner configured to tune the effective length of an array waveguide. The effective length tuners are configured to tune the effective lengths of the array waveguides such that the dispersion profile of the output light signal is tuned.

### RELATED APPLICATIONS

This application is related to U.S. patent application Ser. No. (not yet assigned), filed on Apr. 30, 2001, entitled “Tunable Filter” and incorporated herein in its entirety.

This application is related to U.S. patent application Ser. No. (not yet assigned), filed on May 25, 2001, entitled “Dispersion Compensator” and incorporated herein in its entirety.

### BACKGROUND

1. Field of the Invention

The invention relates to one or more optical networking components. In particular, the invention relates to dispersion compensators.

2. Background of the Invention

Optical networks include optical fibers that carry light signals to a variety of optical components. Each light signal typically includes a distribution of wavelengths. Different wavelengths tend to travel along the optical fibers at different speeds. As a result, the light signal tends to disperse as the light signal travels along the optical fiber. Significant levels of dispersion can affect the performance of the optical network.

For the above reasons, there is a need for optical components that compensate for and/or correct the effects of dispersion.

### SUMMARY OF THE INVENTION

The invention relates to a tunable dispersion compensator. The dispersion compensator includes an array waveguide grating having a plurality of array waveguides. A component is configured to receive portions of a light signal from the array waveguide grating and to combine the portions of the light signal into an output light signal having a dispersion profile. At least a portion of the array waveguides include an effective length tuner configured to tune the effective length of an array waveguide. The effective length tuners are configured to tune the effective length of the array waveguides such that the dispersion profile of the output light signal is tuned.

Another embodiment of the dispersion compensator includes an array waveguide grating having a plurality of array waveguides. Each of the array waveguides is associated with an effective length and is configured to receive a portion of an input light signal. At least a portion of the array waveguides have an effective length tuner for tuning the effective length of an array waveguides. An output waveguide is configured to receive at least a portion of the input light signal portions. The received input light signal portions are combined into an output light signal having an output dispersion profile. The output dispersion profile changes in response to tuning of the effective length tuners.

Yet another embodiment of the dispersion compensator includes an array waveguide grating having a plurality of array waveguides that are each associated with an effective length. At least a portion of the array waveguides include an effective length tuner for tuning the effective lengths of an array waveguide. The array waveguides are configured to carry portions of an input light signal. A component is configured to receive the portions of the input light signal from the array waveguide grating and to combine the portions of an input light signal into an output light signal having a dispersion profile. The dispersion compensator also includes electronics for tuning the effective length tuners such that the dispersion profile of the output light signal changes.

In some instances, the effective length tuners are integrated into a common effective length tuner positioned adjacent to a plurality of the array waveguides.

The array waveguides can be associated with an array waveguide index j. The effective length tuners can be configured to tune the effective lengths such that the amount of the effective length change for an array waveguide is an exponential function with a base that is a function of the array waveguide index. In some instances, the exponential function includes β(j+C)^{α} where C and α are constants and has a value that changes in response to tuning of the effective length tuners.

In some instance, the effective length tuners have an effective area. The length of each effective area extends along a length of an array waveguide. The length of each effective area can be an exponential function with a base that is a function of the array waveguide index. The exponential function can includes B(j+C)^{α}, wherein B, C and α are constants.

In another embodiment, the array waveguides have lengths selected such that a dispersion profile of the input light signal is different than the dispersion profile of the output light signal. The change that occurs to dispersion profiles occurs in addition to the change that occurs from the effective length tuners. In some instances, the length of the array waveguides is an exponential function having a base that is a function of the array waveguide index j.

The invention also relates to a method of tuning the dispersion profile of a light signal. The method includes combining portions of a light signal that exit an array waveguide grating into an output light signal having a dispersion profile. At least a portion of the array waveguides have a tunable effective length. The method also includes tuning the effective length of the array waveguides such that the dispersion profile changes.

In some instances, the array waveguides are associated with an array waveguide index, j, and the effective length of the array waveguides are tuned such that an amount of effective length change for an array waveguide is an exponential function with a base that is a function of the array waveguide index.

### BRIEF DESCRIPTION OF THE FIGURES

FIG. 1A illustrates a dispersion compensator according to the present invention.

FIG. 1B illustrates a dispersion compensator having a single light distribution component.

FIG. 1C illustrates another embodiment of a dispersion compensator having a single light distribution component.

FIG. 2A shows the dispersion profile of an input light signal in an input waveguide of the dispersion compensator.

FIG. 2B illustrates the dispersion profile of an output light signal in an output waveguide. The dispersion profile of the output light signal is narrower than the dispersion profile of the input light signal shown in FIG. 2A.

FIG. 2C shows the dispersion profile of an input light signal in an input waveguide of the dispersion compensator.

FIG. 2D illustrates the dispersion profile of an output light signal in an output waveguide. The dispersion profile of the output light signal is broader than the dispersion profile of the input light signal shown in FIG. 2C.

FIG. 2E shows the dispersion profile of an input light signal in an input waveguide of the dispersion compensator.

FIG. 2F illustrates the dispersion profile of an output light signal in an output waveguide. The dispersion profile of the output light signal has positive dispersion slope relative to the dispersion profile of the input light signal shown in FIG. 2E.

FIG. 2G shows the dispersion profile of an input light signal in an input waveguide of the dispersion compensator.

FIG. 2H illustrates the dispersion profile of an output light signal in an output waveguide. The dispersion profile of the output light signal has positive dispersion slope relative to the dispersion profile of the input light signal shown in FIG. 2H.

FIG. 3 illustrates a dispersion compensator having a demultiplexing function.

FIG. 4A is a perspective view of an optical component including a dispersion compensator.

FIG. 4B is a topview of an optical component having a dispersion compensator.

FIG. 4C is a cross section of the component shown in FIG. 4B at any of the lines labeled A.

FIG. 4D is a perspective view of a portion of an optical component having a reflector.

FIG. 4E is a cross section of the component shown in FIG. 4B at any of the lines labeled A when the component includes a cladding layer.

FIG. 5A illustrates a plurality of array waveguides that each includes an effective length tuner.

FIG. 5B illustrates a common effective length tuner configured to change the effective length of a plurality of array waveguides.

FIG. 6A illustrates a temperature controlled device that serves as a common effective length tuner.

FIG. 6B is a cross section of the component of FIG. 6A taken at the line labeled A.

FIG. 7A illustrates a plurality of array waveguides that each includes a temperature controlled device as an effective length tuner.

FIG. 7B illustrates a temperature control device positioned over the ridge of an array waveguide.

FIG. 7C illustrates a temperature control device positioned adjacent to the sides of the ridge.

FIG. 7D illustrates a temperature control device positioned over the over, adjacent to the sides of the ridge and extending away from the sides of the ridge.

FIG. 8A illustrates a plurality of array waveguides that each includes a plurality of electrical contacts that serve as an effective length tuner. Each effective length tuner includes a first electrical contact positioned over a ridge and a second electrical contact positioned under the ridge.

FIG. 8B is a cross section of FIG. 8A taken at the line labeled A.

FIG. 8C illustrates a component having a cladding layer positioned over the light transmitting medium.

FIG. 9A illustrates a plurality of array waveguides that each includes a plurality of electrical contacts that serve as an effective length tuner. Each effective length tuner includes a first electrical contact positioned over a ridge and a second electrical contact positioned adjacent to a side of the ridge.

FIG. 9B is a cross section of the component shown in FIG. 9A taken at the line labeled A.

FIG. 10A illustrates a common effective length tuner including a plurality of electrical contacts. A first electrical contact positioned over ridges of the array waveguides and a second electrical contact positioned under the ridges.

FIG. 10B is a cross section of the component shown in FIG. 1 OA taken at the line labeled A.

FIG. 11A illustrates a component having a plurality of array waveguides defined in a light transmitting medium positioned over a base. An isolation groove extending through the light transmitting medium is positioned between adjacent array waveguides.

FIG. 11B illustrates the isolation groove extending into the base.

FIG. 11C illustrates the isolation groove undercutting the array waveguides.

FIG. 11D is a topview of a component having bridge regions that each bridges an isolation groove. Electrical conductors are formed on the bridge region.

FIG. 11E is a topview of a component having a bridge region that supports a wedge shaped common effective length tuner.

FIG. 12A illustrates an effective length tuner broken into a plurality of sub effective length tuners. The sub effective length tuners are connected in series with the sub effective length tuners on an array waveguide directly connected to one another.

FIG. 12B illustrates an effective length tuner broken into a plurality of sub effective length tuners. The sub effective length tuners are connected in series with the sub effective length tuners on adjacent array waveguide directly connected to one another.

FIG. 12C illustrates an embodiment of a dispersion compensator having array waveguides with more than one effective length tuner.

FIG. 12D illustrates an embodiment of the dispersion compensator having more than one type of effective length tuner.

FIG. 13A illustrates a component construction having a light transmitting medium positioned over a light barrier.

FIG. 13B illustrates a component construction having a light barrier with a surface positioned between sides. A waveguide is defined adjacent to the surface of the light barrier and a light transmitting medium is positioned adjacent to the sides of the light barrier.

FIG. 13C illustrates the construction of FIG. 13B when an effective length tuner includes a plurality of electrical contacts.

FIG. 14A through FIG. 14G illustrate a method of forming an optical component having a dispersion compensator.

### DETAILED DESCRIPTION OF THE PREFERRED EMBODIMENT

The invention relates to a tunable dispersion compensator. The dispersion compensator includes an array waveguide grating having a plurality of array waveguides. A component is configured to receive portions of a light signal from the array waveguide grating and to combine the portions of the light signal into an output light signal having a dispersion profile. At least a portion of the array waveguides include an effective length tuner configured to tune the effective length of an array waveguide. The effective length tuners are configured to tune the effective length of the array waveguides such that the dispersion profile of the output light signal changes.

The effective length tuners can be configured to tune the effective lengths such that the dispersion compensator provides positive dispersion or negative dispersion. Alternatively or additionally, the effective length tuners can be configured to tune the effective lengths such that the dispersion compensator provides positive dispersion slope or negative dispersion slope. Further, the effective length tuners can be configured to tune the effective lengths such that the dispersion compensator provides tuning of higher order dispersions. As a result, the effective length tuners can be tuned so as to achieve an output light signal with a desired dispersion profile.

Because the output light signal can be tuned to a desired dispersion profile, the dispersion compensator can be used to correct for the effects of dispersion on optical networks. For instance, a dispersion compensator tuned to convert an input light signal to an output light signal having a narrower intensity versus time profile can be positioned before optical components that require narrow intensity versus time profiles. Alternatively, a dispersion compensator tuned to convert an input light signal to an output light signal having a narrower intensity versus time profile can be positioned before long optical fiber runs to compensate for the dispersion that occurs during the optical fiber run.

In some instances, the dispersion compensator is configured to provide a demultiplexing function in addition to changing the dispersion profile. The demultiplexing function causes the light distribution component to direct output light signals having different wavelengths to different output waveguides. Different channels of an optical network are typically carried on light signals having different wavelengths. As a result, a dispersion compensator configured to provide demultiplexing function can cause different channels to appear on different output waveguides with each channel having a desired dispersion profile.

The lengths of the array waveguides can also be selected so as to change the dispersion of the light signal in addition to the change provided by the effective length tuners. The lengths of the array waveguides can be selected to provide positive or negative dispersion, to provide positive or negative dispersion slope and/or to provide higher order dispersion changes.

In some instances, the effective length tuners can be configured to enhance the dispersion effects that result from the lengths of the array waveguides. For instance, when the array waveguides have lengths that provide a change to the amount of dispersion, the effective length tuners can be configured so as to tune the amount of dispersion. Tuning the amount of dispersion can include reversing the dispersion. For instance, when the array waveguides provide positive dispersion, the effective length tuners can be operated so as to provide negative dispersion. When the array waveguides have lengths that provide a change to the dispersion slope, the effective length tuners can be configured so as to tune the amount of dispersion slope. Tuning the amount of dispersion slope can include reversing the dispersion slope. When the array waveguides have lengths that provide a change to higher order dispersions, the effective length tuners can be configured so as to tune the amount of higher order dispersion. Tuning the amount of higher order dispersion can include reversing the higher order dispersion.

The effective length tuners can be configured to change a different order of dispersion than is changed by the lengths of the array waveguides. For instance, when the array waveguides have lengths that provide a change to the amount of dispersion, the effective length tuners can be configured so as to tune the amount of dispersion slope and/or higher order dispersions. When the array waveguides have lengths that provide a change to the dispersion slope, the effective length tuners can be configured so as to tune the amount of higher order dispersions and/or the amount of dispersion. When the array waveguides have lengths that provide a change to higher order dispersions, the effective length tuners can be configured so as to tune a different order dispersion.

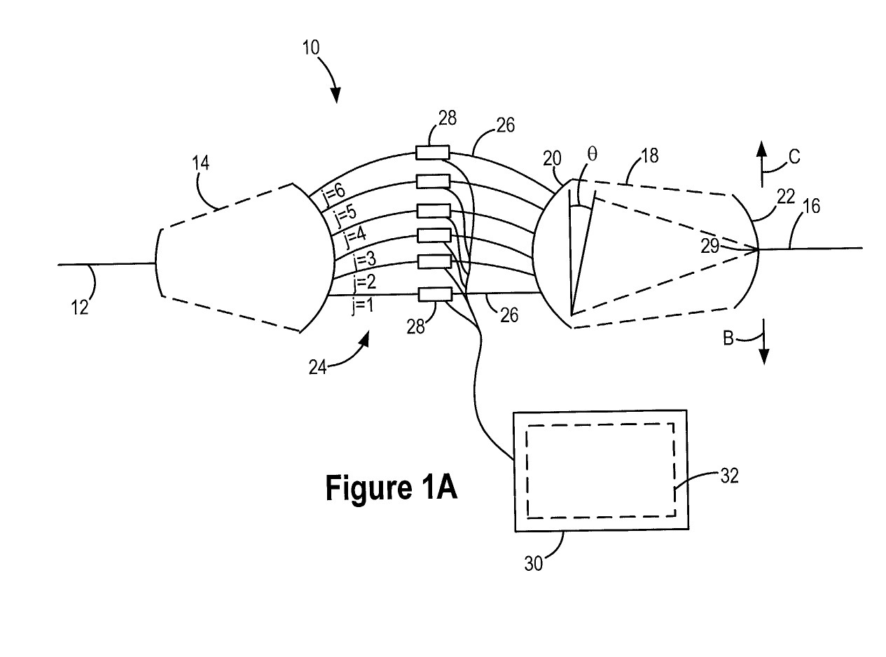

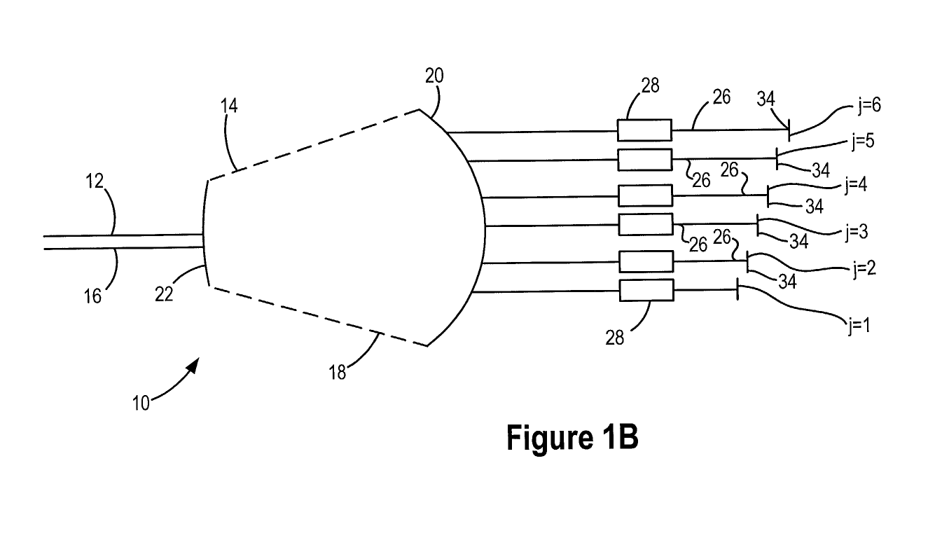

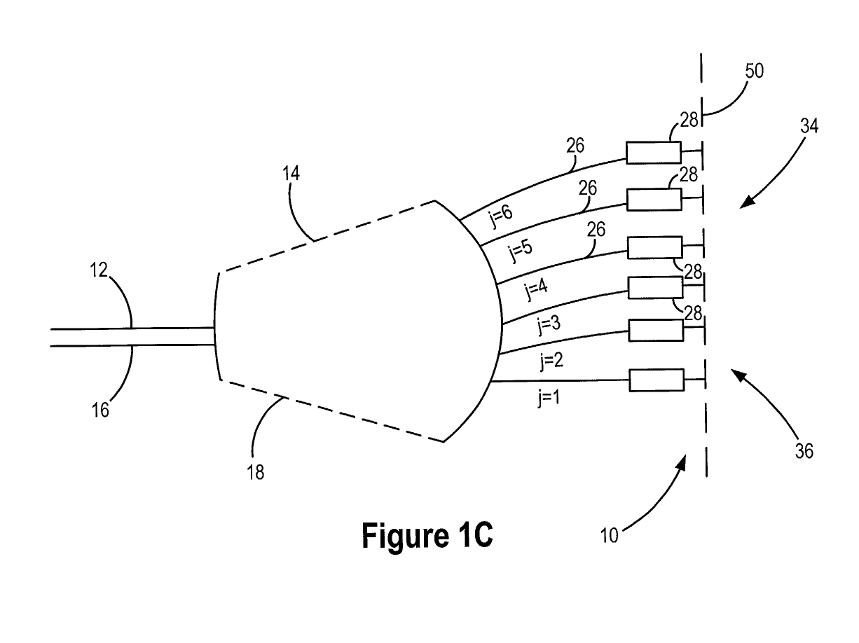

FIG. 1A illustrates an embodiment of a dispersion compensator 10 according to the present invention. The dispersion compensator 10 includes at least one input waveguide 12 in optical communication with an input light distribution component 14 and an output waveguide 16 in optical communication with an output light distribution component 18. The output light distribution component 18 has an input side 20 and an output side 22. A suitable input light distribution component 14 and/or output light distribution component 18 includes, but is not limited to, star couplers, Rowland circles, multi-mode interference devices, mode expanders, free space and slab waveguides. Although a single output waveguide 16 is illustrated, the dispersion compensator 10 can include a plurality of output waveguides 16.

An array waveguide grating 24 connects the input light distribution component 14 and the output light distribution component 18. The array waveguide grating 24 includes a plurality of array waveguides 26. The array waveguides 26 each have a length. Because the array waveguides 26 are often curved, the length is not consistent across the width of the array waveguide 26. As a result, the length is often the length averaged across the width of the array waveguide 26. Although six array waveguides 26 are illustrated, array waveguide gratings typically include many more than six array waveguides 26 and fewer are possible. Increasing the number of array waveguides 26 can increase the degree of resolution provided by the array.

During operation of the dispersion compensator 10, an input light signal enters the input light distribution component 14 from the input waveguide 12. For the purposes of simplifying the discussion, the input light signal is presumed to be a single channel light signal. The input light distribution component 14 distributes the input light signal to the array waveguides 26. Each array waveguide 26 receives a portion of the input light signal. Each array waveguide 26 carries the received input light signal portion to the output light distribution component 18. The light signal portion entering the output light distribution component 18 from each of the array waveguides 26 combines to form an output light signal. The output light distribution component 18 is constructed to converge the light signal at a location on the output side 22 of the output light distribution component 18. As illustrated in FIG. 1A, the output light signal is converged at the output waveguide 16 labeled A. As a result, the output light signal appears on the output waveguide 16.

The array waveguides 26 each include an effective length tuner 28 for tuning the effective length of the array waveguide 26. In some instances, the effective length tuners 28 are configured to increase the effective length of the array waveguides 26. In other instances, the effective length tuners 28 are configured to decrease the effective length of the array waveguides 26. In still other instances, the effective length tuners 28 are configured to increase or decrease the effective length of the array waveguides 26.

Although changing the effective length of an array waveguide 26 can be accomplished by changing the physical length of the array waveguide 26, other methods for changing the effective length are possible. For instance, the effective length of an array waveguide 26 can be changed by changing the amount of time required for a light signal to travel through the array waveguide 26. When the array waveguide 26 is changed so a longer time is required for a light signal to travel through the array waveguide 26, the effective length of the array waveguide 26 is increased and when the array waveguide 26 is changed so a shorter period of time is required for the light signal to travel through the array waveguide 26, the effective length is decreased. As will be discussed in more detail below, one method of changing the effective length of an array waveguide 26 is to change the index of refraction of the array waveguide 26.

Although not illustrated, a temperature electronic controller (TEC) can be employed to keep the temperature of the dispersion compensator 10 at a constant level.

A controller 30 is in communication with the effective length tuners 28. The controller 30 can include electronics 32 for operating the effective length tuners 28. The electronics 32 can include one or more processors. Suitable processors include, but are not limited to, programmed general purpose digital computers, microprocessors, digital signal processors (DSP), integrated circuits, application specific integrated circuits (ASICs), logic gate arrays and switching arrays.

The electronics 32 can include one or more machine readable media for storing instructions to be executed by the processor and/or for storing information to be used by the processor while executing instructions. Suitable machine readable media include, but are not limited to, RAM, electronic read-only memory (e.g., ROM, EPROM, or EEPROM), or transmission media such as digital and/or analog communication links.

The electronics 32 are configured to control the effective length tuners 28 so as to tune the effective length of the array waveguides 26. The effective length of the array waveguides 26 is tuned so the dispersion compensator provides the desired dispersion compensation.

The dispersion compensator shown in FIG. 1A can be constructed with a single light distribution component 14 by positioning reflectors 34 along the array waveguides as shown in FIG. 1B. The dispersion compensator 10 includes an input waveguide 12 and an output waveguide 16 that are each connected to the output side 22 of the input light distribution component 14. The array waveguides 26 include a reflector 34 configured to reflect light signal portions back toward the light distribution component.

During operation of the dispersion compensator 10, an input light signal from the input waveguide 12 is distributed to the array waveguides 26. The array waveguides 26 carry the light signal portions to the reflector 34 where they are reflected back toward the input light distribution component 14. The input light distribution component combines the light signal portions so form the output light signal and converge the output light signal at the output waveguide 16. As a result, the output waveguide 16 carries the output light signal.

The light signal portions travel through each array waveguide 26 twice. As a result, the light signal portions experiences the effects of the effective length tuners more than once. Accordingly, the effects of the effective length tuners are enhanced. The enhanced effect can provide for a more efficient dispersion compensator. For instance, the same effective length tuners can provide a dispersion compensator according to FIG. 1B with a larger amount of dispersion compensation than is achieved with a dispersion compensator according to FIG. 1A. Further, less power can be applied to the effective length tuners of FIG. 1B than is applied to the same effective length tuners used in the dispersion compensator of FIG. 1A to achieve the same level of dispersion compensation.

FIG. 1C illustrates another embodiment of a dispersion compensator 10 having a single light distribution component and curved array waveguides 26. The dispersion compensator 10 is included on an optical component 36. The edge of the optical component 36 is shown as a dashed line. The edge of the optical component can include one or more reflective coatings positioned so as to serve as reflector(s) 34 that reflect light signals from the array waveguides back into the array waveguides. Alternatively, the edge of the optical component can be smooth enough to act as a mirror that reflects light signals from the array waveguide back into the array waveguide. The smoothness can be achieved by polishing, buffing or cleaving. An optical component having a dispersion compensator according to FIG. 1C can be fabricated by making an optical component having a dispersion compensator 10 according to FIG. 1A and cleaving the optical component 36 down the center of the array waveguides. When the optical component 36 was symmetrical about the cleavage line, two optical components can result. Because, the light signal must travel through each array waveguide twice, each resulting dispersion compensators will provide about the same dispersion compensation as would have been achieved before the optical component 36 was cleaved.

Although the dispersion compensator 10 of FIG. 1A, FIG. 1B and FIG. 1C is shown with a single input waveguide 12 and a single output waveguide, the dispersion compensator 10 can include a plurality of input waveguides 12 and/or a plurality of output waveguides as will be discussed in more detail below.

The effective length tuners are configured to change the dispersion of a light signal traveling through the dispersion compensator. FIG. 1A, FIG. 1B and FIG. 1C each include array waveguides labeled with an array waveguide index j=1 through N. The effective length tuners are configured to change the effective length of the array waveguides such that the amount of effective length change, ELC(j), for an array waveguide is an exponential function with a base that is a function of the array waveguide index j. The exponential function causes the dispersion profile of the output light signal to be different from the dispersion profile of the input light signal. The dispersion profile of a light signal is the intensity versus time profile of the light signal.

Equation 1 is an example of a suitable exponential function where f(j) indicates a function of the array waveguide index j and α is a constant. Because the array waveguides 26 are often curved, effective length change is often not uniform across the width of the array waveguide 26. As a result, the effective length change can be a reference to the effective length change averaged across the width of the array waveguide 26, the effective length change at a particular location across the width of the array waveguide or another measure of the effective length change.

ELC(j)=γ+β(f(j)) (1)

A suitable f(j) includes, but is not limited to, j+C as shown in Equation 2. The C is a constant value for each array waveguide 26 and can be zero.

ELC(j)=γ+β(j+C) (2)

When the dispersion compensator is tuned, the value of γ+β change. For instance, tuning of the dispersion compensator includes changing the effective lengths of the array waveguides such that Equation 2 stays true. In order for Equation 2 to remain true during tuning, the value of γ and β must also change during tuning. For instance, when the effective length tuners are disengaged, the value of β and γ are zero and the effective length tuners do not affect dispersion. However, the value of γ+β changes as the effective length tuners are tuned. The effective lengths can be tuned such that the value of β is positive or negative. The effective lengths can be tuned such that the value of γ is positive, negative or zero.

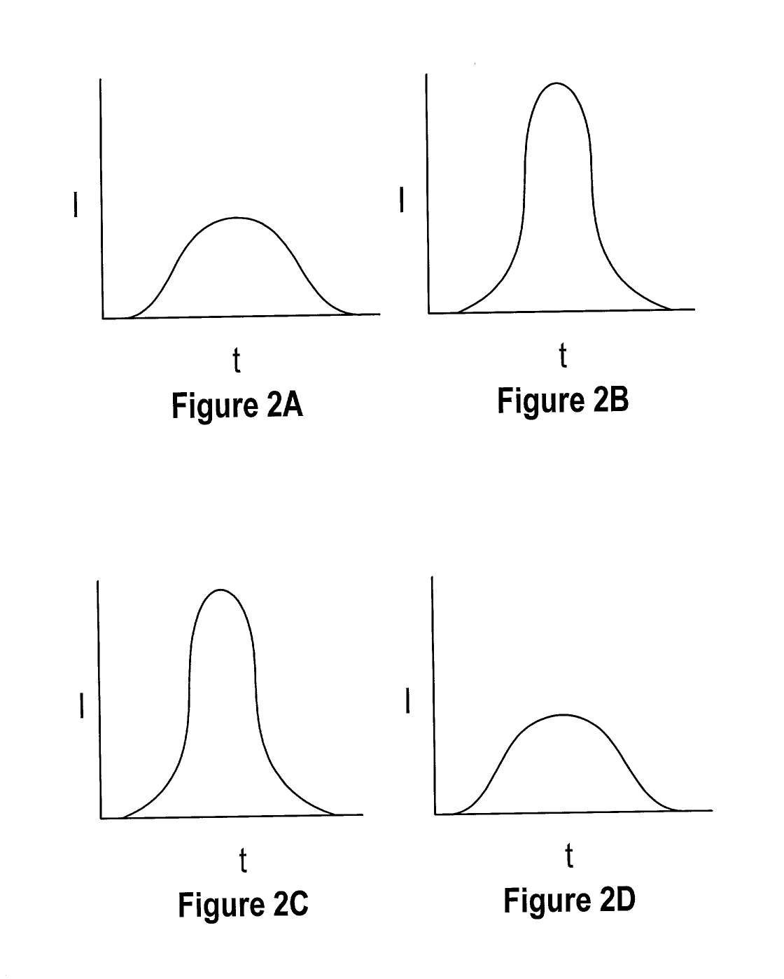

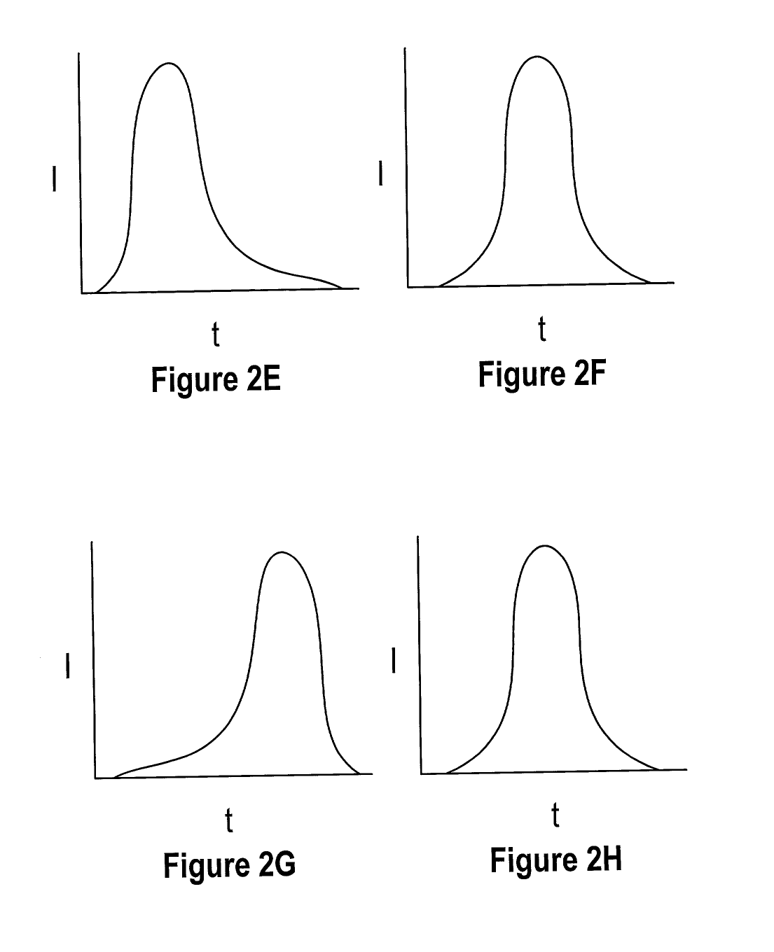

When α is equal to 2 and the effective length tuners are tuned such that β is negative, the dispersion profile narrows as shown in FIG. 2A and FIG. 2B. FIG. 2A shows the dispersion profile of the input light signal and FIG. 2B shows the dispersion profile of the output light signal. The dispersion profile of the output light signal is narrower than the dispersion profile of the input light signal. Accordingly, the array waveguide grating 24 causes the input light signal to undergo negative dispersion. This negative dispersion change can be generated from the phase 2*π*ELC(j)/λ where n_{c} is effective refractive index of the waveguide. The degree of dispersion change increases as the magnitude of β increases. Accordingly, tuning the effective length tuners so as to further decrease the value of β provides the output light signal with a narrower dispersion profile.

When α is equal to 2 and the effective length tuners are tuned such that β is positive, the dispersion profile broadens as shown in FIG. 2C and FIG. 2D. FIG. 2C shows the dispersion profile of the input light signal and FIG. 2D shows the dispersion profile of the output light signal. The dispersion profile of the output light signal is broader than the dispersion profile of the input light signal. Accordingly, the array waveguide grating 24 causes the input light signal to undergo positive dispersion. This positive dispersion can be generated from the phase 2*π*ELC(j)/λ. The degree of dispersion change increases as the magnitude of β increases. Accordingly, tuning the effective length tuners so as to further increase the value of β provides the output light signal with a broader dispersion profile.

Other values of α and β can be used to change other features of the dispersion profile. For instance, when α is greater than 2 and the effective length tuners are tuned such that β is positive, positive dispersion slope results as shown in FIG. 2E and FIG. 2F. FIG. 2E shows the dispersion profile in the input waveguide 12 and FIG. 2F shows the dispersion profile in the output waveguide 16. The array waveguide grating 24 causes the output dispersion profile to shift toward longer times as compared to the input light signal. The degree of dispersion slope change increases as the magnitude of β increases. Accordingly, tuning the effective length tuners so as to further increase the value of β shifts the dispersion profile further toward longer times.

When α is greater than 2 and β is negative and the effective length tuners are tuned such that β is negative, negative dispersion slope results as shown in FIG. 2G and FIG. 2H. FIG. 2G shows the dispersion profile in the input waveguide 12 and FIG. 2H shows the dispersion profile in the output waveguide 16. The array waveguide grating 24 causes the output dispersion profile to shift more toward shorter times than the input light signal. The degree of dispersion slope change increases as the magnitude of β increases. Accordingly, tuning the effective length tuners so as to further decrease the value of β shifts the dispersion profile further toward shorter times.

When α is increased to three or higher the dispersion compensator can compensate for higher order dispersion. The dispersion compensator 10 has the ability to compensate an arbitrary dispersion response using higher order ELC(j) and dispersion changing function, L_{DC}, which will be discussed below. The degree of higher order dispersion change will increase as the magnitude of β increases. Accordingly, tuning the effective length tuners so as to further increase the magnitude of β provides a greater degree change in the higher order dispersion.

A suitable C for use in equation 2 includes, but is not limited to, a function of N. A suitable function of N includes, but is not limited to, −(N+1)/2 as shown in Equation 3 and −N/2. When C is −(N+1)/2, the exponential function is centered relative to the array waveguides 26. More specifically, the array waveguide(s) 26 having the smallest value of L(j) is the (N+1)/2 th array waveguide when the number of array waveguides 26 is odd and is the N/2−0.5 th and N/2+0.5 th array waveguides 26 when the number of array waveguides 26 is even. The exponential function need not be centered relative to the array waveguides 26 in order for the dispersion compensator 10 to operate. For instance, C can be equal to zero.

ELC(j)=γ+β(j−(N+1)/2)^{α} (3)

The effects of the exponential functions described above are additive. As a result, the effective length tuners can be operated so as to tune more than one order of dispersion. For instance, the effective length tuners can be operated so as to produce negative dispersion and positive dispersion slope. As a result, the effective length tuners could be operated so as to provide an output light signal that is narrower and more shifted toward the longer times than the dispersion profile on the input waveguide 12. Other combinations include, but are not limited to, negative dispersion and negative dispersion slope; positive dispersion and positive dispersion slope or positive dispersion and negative dispersion slope.

Equation 4 shows an equation for operating effective length tuners so as to tune more than one order of dispersion.

ELC(j)=γ+β(j+C)^{α}+γ′+β′(j+C′)^{α′} (4)

The value of γ, γ′α, α′, β, β′, C and C′ are selected so as to achieve the desired combination of dispersion order tuning. For instance, when it is desired to tune dispersion and dispersion slope, the value of α is 2 for tuning dispersion and α′ is greater than 2 for tuning dispersion slope. The values of β and β′ are often less than one.

The lengths of the array waveguides can also be selected so as to change the dispersion of the light signal. For instance, the length of the array waveguides can be selected to provide positive or negative dispersion, to provide positive or negative dispersion slope and/or to provide higher order dispersion changes.

In some instances, the effective length tuners can be configured to enhance the dispersion effects that result from the lengths of the array waveguides. For instance, when the array waveguides have lengths that provide a change to the amount of dispersion, the effective length tuners can be configured so as to tune the amount of dispersion. Tuning the amount of dispersion can include reversing the dispersion. For instance, when the array waveguides provide positive dispersion, the effective length tuners can be operated so as to provide negative dispersion. When the array waveguides have lengths that provide a change to the dispersion slope, the effective length tuners can be configured so as to tune the amount of dispersion slope. Tuning the amount of dispersion slope can include reversing the dispersion slope. When the array waveguides have lengths that provide a change to higher order dispersions, the effective length tuners can be configured so as to tune the amount of higher order dispersion. Tuning the amount of higher order dispersion can include reversing the higher order dispersion.

The effective length tuners can be configured to change a different order of dispersion than is changed by the lengths of the array waveguides. For instance, when the array waveguides have lengths that provide a change to the amount of dispersion, the effective length tuners can be configured so as to tune the amount of dispersion slope and/or higher order dispersions. When the array waveguides have lengths that provide a change to the dispersion slope, the effective length tuners can be configured so as to tune the amount of higher order dispersions and/or the amount of dispersion. When the array waveguides have lengths that provide a change to higher order dispersions, the effective length tuners can be configured so as to tune the amount of a different order dispersion.

The length of array waveguides configured to change the dispersion can have a constant component, Lo, and one or more variable components, L(j). The constant component, Lo, can be a length that is the same for each array waveguide 26 and can be equal to zero. The variable component, L(j), is a function of the particular array waveguide index. For instance, the array waveguides 26 can each be associated with an array waveguide index, j. The length of each array waveguide 26 is L=Lo+L(j). Because the array waveguides 26 are often curved, the length of an array waveguide is often not uniform across the width of the array waveguide 26. As a result length can be a reference to the length averaged across the width of the array waveguide 26, the length at a particular location across the width of the array waveguide or another measure of array waveguide length.

The variable component, L(j), can include a dispersion changing function, L_{DC}(j), that causes the output light signal to have a different dispersion profile than the input light signal. A suitable dispersion changing function, L_{DC}(j), includes, but is not limited to, an exponential function with a base that is a function of the array waveguide index j. The exponential function causes the dispersion profile of the input light signal to be different from the dispersion profile of the output light signal. Equation 5 is an example of a suitable exponential function where f(j) indicates some function of the array waveguide index j and δ and ε are constants.

L(j)=L_{DC}(j)=δ(f(j))^{ε} (5)

A suitable f(j) includes, but is not limited to, j+C as shown in Equation 6. The C is a constant.

L(j)=L_{DC}(j)=δ(j+C)^{ε} (6)

When ε is equal to 2 and δ is negative, the dispersion profile narrows such that the dispersion profile of the output light signal becomes narrower than the dispersion profile of the input light signal. Accordingly, the array waveguides causes the input light signal to undergo negative dispersion. This negative dispersion change can be generated from the phase 2*π*n_{c}*L_{DC}/λ where n_{c} is effective refractive index of the waveguide. The degree of dispersion change increases as the magnitude of δ increases. Accordingly, δ can be made more negative when a narrower dispersion profile is desired.

When ε is equal to 2 and δ is positive, the dispersion profile the dispersion profile broadens such that the dispersion profile of the output light signal becomes broader than the dispersion profile of the input light signal. Accordingly, the array waveguides cause the input light signal to undergo positive dispersion. This positive dispersion can be generated from the phase 2*π*n_{c}*L_{DC}/λ. The degree of dispersion change increases as the magnitude of δ increases. Accordingly, δ can be made more positive when a broader dispersion profile is desired.

Other values of δ and ε can be used to change other features of the dispersion profile. For instance, when ε is greater than 2 and 6 is positive, positive dispersion slope results. The degree of dispersion slope change increases as the magnitude of δ increases. Accordingly, δ can be made more positive when a more positive dispersion slope is desired.

When ε is greater than 2 and 6 is negative, negative dispersion slope results. The degree of dispersion slope change increases as the magnitude of δ increases. Accordingly, δ can be made more negative when a more negative dispersion slope is desired.

When ε is increased to three or higher the dispersion compensator can compensate for higher order dispersion. In other words, the dispersion compensator 10 has the ability to compensate an arbitrary dispersion response using higher order dispersion changing functions.

A suitable C for use in equation 6 includes, but is not limited to, a function of N. A suitable function of N includes, but is not limited to, −(N+1)/2 as shown in Equation 7 and −N/2. When C is −(N+1)/2, the exponential function is centered relative to the array waveguides 26. More specifically, the array waveguide(s) 26 having the smallest value of L(j) is the (N+1)/2 th array waveguide when the number of array waveguides 26 is odd and is the N/2−0.5 th and N/2+0.5 th array waveguides 26 when the number of array waveguides 26 is even. The exponential function need not be centered relative to the array waveguides 26 in order for the dispersion compensator 10 to operate. For instance, C can be equal to zero.

L(j)=L_{DC}(j)=δ(j−(N+1)/2)^{ε} (7)

The effects of the variable component, L(j), are additive. As a result, the length of the array waveguides 26 can include more than one variable component, L(j). For instance, the array waveguides can be configured so as to produce negative dispersion and positive dispersion slope. As a result, the dispersion profile on the output waveguide 16 would be narrower and more shifted toward the longer times than the dispersion profile on the input waveguide 12. Other combinations include, but are not limited to, negative dispersion and negative dispersion slope; positive dispersion and positive dispersion slope or positive dispersion and negative dispersion slope.

Equation 8 shows an equation for the length of array waveguides 26 having more than one variable component, L(j).

L(j)=Lo+L_{DC}(j)+L′_{DC}(j)=Lo+δ(j+C)^{ε}+δ′(j+C′)^{ε′} (8)

The value of δ, δ′, ε, ε′, C and C′ are selected so as to achieve the desired combination of variable component effects. For instance, when it is desired to produce a dispersion compensator 10 having negative dispersion and positive dispersion slope, the value of ε is 2 and δ is negative in order to provide the negative dispersion and ε′ is greater than 2 and δ′ is positive in order to provide the positive dispersion slope. The values of δ and δ′ are often less than one.

The variable component, L(j), can include a demultiplexing function, L_{D}(j), in addition to a dispersion changing function, L_{DC}(j). When different channels are carried on light signals having different wavelengths, the demultiplexing function, L_{D}(j), causes the light distribution component to direct different channels to different locations on the output side 22 of the light distribution component. A suitable demultiplexing function, L_{D}(j), includes, but is not limited to, L_{D}(j)=jΔL or (j−1)ΔL where ΔL is a constant.

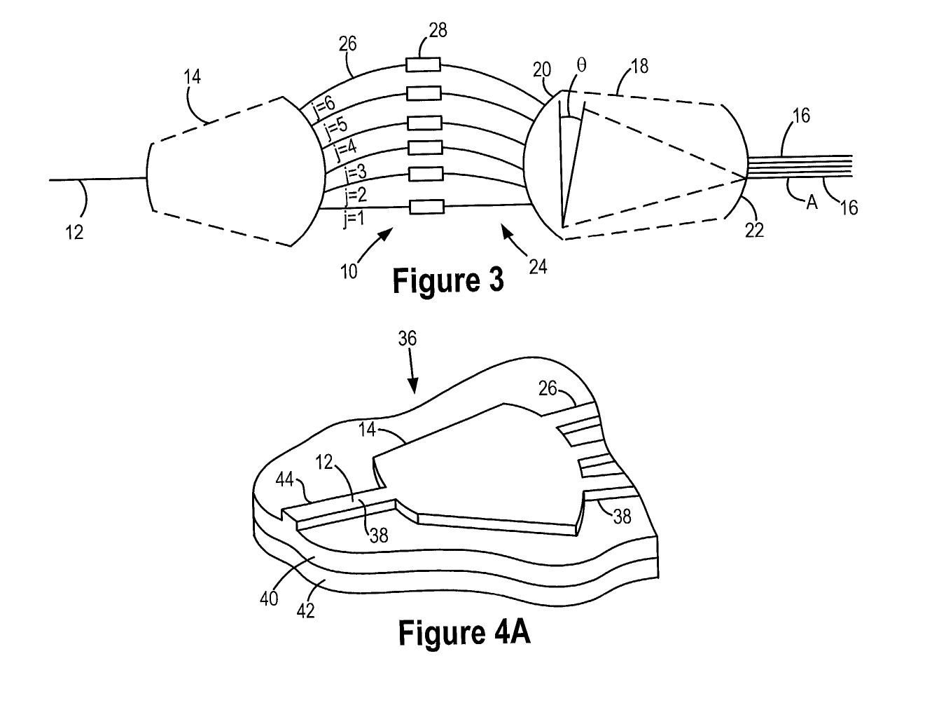

FIG. 3 illustrates an example of a dispersion compensator 10 having an array waveguide grating configured to provide a demultiplexing function, L_{D}(j). The dispersion compensator 10 includes a plurality of output waveguides 16 positioned at locations along the output side 22 of the light distribution component. The output waveguides 16 are each positioned to receive a particular one of the channels. Accordingly, each output waveguide 16 carries a particular channel. Alternatively, all or a portion of the output waveguides can be positioned to receive a band of the channels. For instance, one or more of the output waveguides can be configured to receive two or more of the channels that are adjacent to one another in the wavelength spectrum. Output waveguides configured to receive more than one channel are associated with a band of channels. The dispersion compensator changes the dispersion of each channel in a band of channels carried on an output waveguide.

When a dispersion compensator constructed according to FIG. 1A includes an array waveguide grating configured to have a demultiplexing function, the output waveguide will carry one of the channels or a band of adjacent channels. As a result, when the input light signal has a plurality of channels, the dispersion compensator can be constructed to output one of the channels with a tuned dispersion profile. When a dispersion compensator constructed according to FIG. 1A includes an array waveguide grating that is not configured to have a demultiplexing function, the output waveguide will carries each of the channels in the input light signal. As a result, when the input light signal has a plurality of channels, the dispersion compensator can be constructed to output on a single output waveguide each of the channels with a tuned dispersion profile.

Although FIG. 3 illustrates a single input waveguide 12, the dispersion compensator 10 can include a plurality of input waveguides 12.

In order to simplify describing operation of a dispersion compensator 10 having a demultiplexing function, L_{D}(j), it is presumed that the variable component, L(j) is equal to the demultiplexing function, L_{D}(j). During operation of the dispersion compensator 10 so as to provide a demultiplexing function, L_{D}(j), each array waveguide 26 carries the received light signal portion to the output light distribution component 18. A light signal portion traveling through a long array waveguide 26 will take longer to enter the output light distribution component 18 than a light signal portion light traveling through a shorter array waveguide 26. Unless the length differential, ΔL, between adjacent array waveguide 26 is a multiple of the light wavelength, the light signal portion traveling through a long array waveguide 26 enters the output light distribution component 18 in a different phase than the light signal portion traveling along the shorter array waveguide 26.

The light signal portion entering the output light distribution component 18 from each of the array waveguides 26 combines to form the output light signal. Because the array waveguide 26 causes a phase differential between the light signal portions entering the output light distribution component 18 from adjacent array waveguides 26, the output light signal is diffracted at an angle labeled, θ. The output light distribution component 18 is constructed to converge the output light signal at a location on the output side 22 of the output light distribution component 18. The location where the output light signal is incident on the output side 22 of the output light distribution component 18 is a function of the diffraction angle, θ. As illustrated in FIG. 3, the phase differential causes the output light signal to be converged at the output waveguide 16 labeled A. As a result, the output light signal appears on the output waveguide 16 labeled A.

Because ΔL is a different portion of the wavelength for each channel, the amount of the phase differential is different for different channels. As a result, different channels are diffracted at different angles and are accordingly converged at different locations on the output side 22. Hence, when a multichannel beam enters the output light distribution component 18, each of the different channels is converged at a different location on the output side 22. The output waveguides 16 are positioned at each location on the output side 22 where a channel is converged. As a result, each output waveguide 16 carries a different channel.

The demultiplexing function, L_{D}(j), is additive with the one or more dispersion changing functions, L_{DC}(j). As a result, the variable component, L(j), can include one or more dispersion changing functions, L_{DC}(j), and a demultiplexing function, L_{D}(j). When the array waveguide grating 24 is configured to have one or more demultiplexing functions, L_{D}(j), and a dispersion changing function, L_{DC}(j), the output light signal associated with each channel exhibits the effects of the dispersion changing function, L_{DC}(j). For instance, when the dispersion changing function, L_{DC}(j), provides a narrowing of the dispersion profile, each of the output light signals on an output waveguide 16 has a narrower dispersion profile than the associated input light signal had on the input waveguide 12. Accordingly, the dispersion compensator 10 can concurrently provide dispersion changing functions, L_{DC}(j), and a demultiplexing function, L_{D}(j).

Equation 9 shows an equation for the length of array waveguides 26 for an array waveguide grating 24 having both a demultiplexing function, L_{D}(j), and a dispersion changing function, L_{DC}(j). The value of ΔL, δ and ε are selected so as to achieve the desired combination of demultiplexing and dispersion. For instance, when it is desired to produce demultiplexing and negative dispersion, ΔL is not equal to zero, the value of ε is 2 and δ is negative.

L(j)=Lo+L_{D}(j)+L_{DC}(j)=Lo+jΔL+δ(j+C)^{ε} (9)

As noted above, the dispersion changing functions, L_{DC}(j), are additive. As a result, Equation 9 can include two or more dispersion changing functions, L_{DC}(j), as shown in Equation 10.

L(j)=Lo+L_{D}(j)+L_{DC}(j)+L′_{DC}(j) (10)

When the value of n_{c} is substantially constant along the length of an array waveguide, the total effective length of the j th array waveguide, TEL(j), can be approximated using equation 11. However, when the effective length tuners are tuned, the value of n_{c} changes adjacent to the effective length tuner. As a result, the value of n_{c} changes along the length of an array waveguide. When the value of n_{c} changes along the length of an array waveguide, TEL(j) can be approximated by integrating n_{c} dL along the length of the array waveguide. The amount of effective length change for the j th array waveguide, ELC(j) can be measured by subtracting the value of TEL(j) before tuning from the value of TEL(j) after tuning.

TEL(j)=n_{c}L(j) (11)

The effective length change, ELC(j), and/or the dispersion changing function L_{DC}(j) can cause the bandwidth of the demultiplexing function to change. The amount of bandwidth change is often negligible or can be designed around. The amount of the bandwidth change is reduced with reduced values of b and d. The amount of bandwidth change is generally low when b and d are less than one.

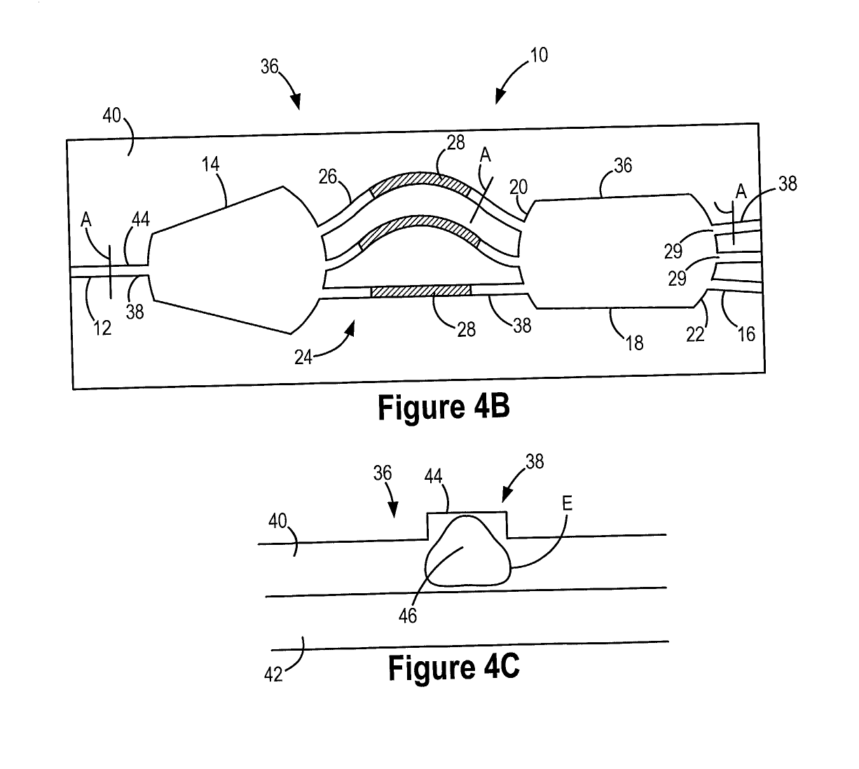

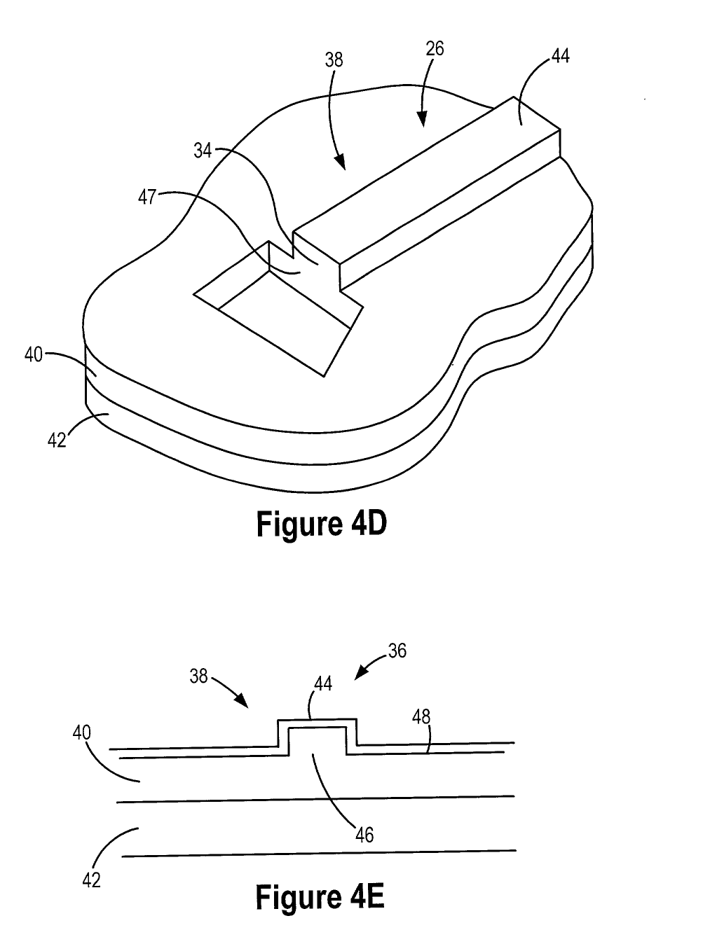

FIG. 4A illustrates a suitable construction for an optical component 36 having a dispersion compensator 10 according to the present invention. A portion of the dispersion compensator 10 is shown on the component 36. The illustrated portion has an input light distribution component 14, an input waveguide 12 and a plurality of array waveguides 26. FIG. 4B is a topview of an optical component 36 having a dispersion compensator 10 constructed according to FIG. 1A. FIG. 4C is a cross section of the component 36 in FIG. 4B taken at any of the lines labeled A. Accordingly, the waveguide 38 illustrated in FIG. 4C could be the cross section of an input waveguide 12, an array waveguide 26 or an output waveguide 16.

For purposes of illustration, the dispersion compensator 10 is illustrated as having three array waveguides 26 and an output waveguide 16. However, array waveguide gratings 24 for use with a dispersion compensator 10 can have many more than three array waveguides 26. For instance, array waveguide gratings 24 can have tens to hundreds or more array waveguides 26.

The component 36 includes a light transmitting medium 40 formed over a base 42. The light transmitting medium 40 includes a ridge 44 that defines a portion of the light signal carrying region 46 of a waveguide 38. Suitable light transmitting media include, but are not limited to, silicon, polymers, silica, SiN, LiNbO₃, GaAs and InP. As will be described in more detail below, the base 42 reflects light signals from the light signal carrying region 46 back into the light signal carrying region 46. As a result, the base 42 also defines a portion of the light signal carrying region 46. The line labeled E illustrates the profile of a light signal carried in the light signal carrying region 46 of FIG. 4C. The light signal carrying region 46 extends longitudinally through the input waveguide 12, the input light distribution component 14, each the array waveguides 26, the output light distribution component 18 and each of the output waveguides 16.

FIG. 4D illustrates a suitable construction of a reflector 34 for use with a dispersion compensator 10 constructed in accordance with FIG. 1B. The reflector 34 includes a reflecting surface 47 positioned at an end of an array waveguide 26. The reflecting surface 47 is configured to reflect light signals from an array waveguide 26 back into the array waveguide 26. The reflecting surface 47 extends below the base of the ridge 44. For instance, the reflecting surface 47 can extend through the light transmitting medium 40 to the base 42 and in some instances can extend into the base 42. The reflecting surface 47 extends to the base 42 because the light signal carrying region 46 is positioned in the ridge 44 as well as below the ridge 44 as shown in FIG. 4C. As result, extending the reflecting surface 47 below the base 42 of the ridge 44 increases the portion of the light signal that is reflected.

A cladding layer 48 can be optionally be positioned over the light transmitting medium 40 as shown in FIG. 4E. The cladding layer 48 can have an index of refraction less than the index of refraction of the light transmitting medium 40 so light signals from the light transmitting medium 40 are reflected back into the light transmitting medium 40. Because the cladding layer 48 is optional, the cladding layer 48 is shown in some of the following illustrations and not shown in others.

The array waveguides 26 of FIG. 4B are shown as having a curved shape. A suitable curved waveguide 38 is taught in U.S. patent application Ser. No. 09/756498, filed on Jan. 8, 2001, entitled “An efficient Curved Waveguide” and incorporated herein in its entirety. Other dispersion compensator 10 constructions can also be employed. For instance, the principles of the invention can be applied to dispersion compensators 10 having straight array waveguides 26. Dispersion compensators 10 having straight array waveguides 26 are taught in U.S. patent application Ser. No. 09/724,175, filed on Nov. 28, 2000, entitled “A Compact Integrated Optics Based Array Waveguide Demultiplexer” and incorporated herein in its entirety.

The array waveguide grating 24 illustrated in FIG. 4B can be controlled so as to change the dispersion of a light signal traveling through the dispersion compensator. Each array waveguide 26 includes an effective length tuner 28 for changing the effective length of the array waveguide 26.

A variety of effective length tuners 28 can be used in conjunction with the array waveguides 26. For instance, each effective length tuner 28 can be a temperature control device such as a resistive heater. Increasing the temperature of the light transmitting medium 40 causes the index of refraction of the light transmitting medium 40 to increase and accordingly increases the effective length. Alternatively, each effective length tuner 28 can include an electrical contact configured to cause flow of an electrical current through the array waveguide 26. The electrical current causes the index of refraction of the light transmitting medium 40 to decrease and accordingly decreases the effective length. Increasing the level of current increases the reduction in effective length. Further, each effective length tuner 28 can include an electrical contact configured to cause formation of an electrical field through the array waveguide 26. The electrical field causes the index of refraction of the light transmitting medium 40 to increase and accordingly increases the effective length. Increasing the electrical field increases the effective length. Other effective length tuners are possible. For instance, the index of refraction of a light transmitting medium often changes in response to application of a force to the light transmitting medium. As a result, the effective length tuner can apply a force to the light transmitting medium. A suitable device for application of a force to the light transmitting medium is a piezoelectric crystal. The index of refraction of a light transmitting medium also changes in response to application of magnet to the light transmitting medium. As a result, the effective length tuner can apply a tunable magnetic field to the light transmitting medium. A suitable device for application of a magnetic field to the light transmitting medium is a magnetic-optic crystal.

As noted above, the effective length tuners 28 are configured to change the effective length of the array waveguides 26 so as to tune the dispersion of a light signal. As discussed in the context of Equation 2, the change in dispersion can be achieved by changing the lengths of the array waveguides such that the amount of effective length change for j th array waveguide is γ+β(j+C)^{α}.

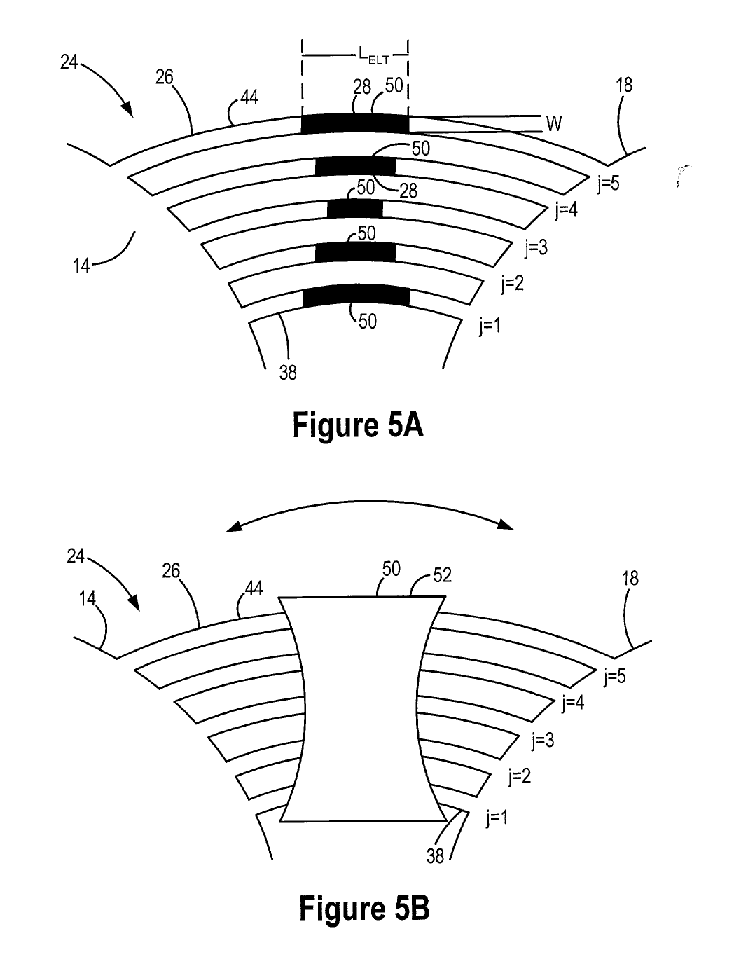

FIG. 5A illustrates effective length tuners configured to change the effective lengths of the array waveguides in accordance with equation 1. The effective area 50 of each effective length tuner 28 is shown. The effective area 50 of an effective length tuner 28 is the array waveguide 26 which is affected by an effective length tuner 28. Each effective area 50 has an effective area width, W, and an effective area length, L_{ELT}. The effective area width, W, is about the same for each array waveguide 26. Because the array waveguides 26 are often curved, effective area length, L_{ELT} is often not uniform across the width of the array waveguide 26. As a result, the effective area length, L_{ELT} can be a reference to the effective area length averaged across the width of the array waveguide 26, the effective area length at a particular location across the width of the array waveguide or another measure of the effective area length.

The effective area length, L_{ELT}, can be determined according to Equation 12. A suitable f(j) includes, but is not limited to, j+C. Equation 12 is the same as Equation 1 with the exception that B and G are constants in Equation 12 where γ and β in Equation 1 vary with tuning. As a result, the length ratio for adjacent effective length tuners is about the same as the effective length change ratio that results from the same effective length tuners. Hence, when the effective length tuners 28 are configured so the change in effective length per unit of effective area length is about the same for each effective length tuner 28, Equation 1 represents the amount of change in effective length caused by effective length tuners designed according to Equation 12. For instance, the value of β is zero when the effective length tuners are disengaged. However, the value of β increases as the effective length tuners are engaged so as to increase the effective length of the array waveguides and the value of β decreases as the effective length tuners are engaged so as to decrease the effective length of the array waveguides.

L_{ELT}(j)=G+B(f(j))^{α} (12)

Equation 12 can be used to design effective length tuners that can provide the desired dispersion tuning. For instance, when tuning of the dispersion is desired, the effective length tuners can have lengths according to Equation 12 with α equal to 2. When tuning of the dispersion slope is desired, the effective length tuners can have lengths according to Equation 12 with α greater than 2. When tuning of the dispersion slope is desired, the effective length tuners can have lengths according to Equation 8 with α greater than or equal to 3.

The value of B can be selected in response to the needed dispersion tuning range. For instance, a larger value of B will provide a larger value of β and accordingly a larger range of dispersion tuning.

The effective length tuners of FIG. 5A can be integrated into a common effective length tuner as illustrated in FIG. 5B. The common effective length tuner 52 can change the effective length of the portions of the component 36 positioned between the array waveguides 26. The common effective length tuner 52 is designed to have an effective area that preserves the length relationships discussed with respect to FIG. 5A. As a result, the effective area of the common effective length tuner can have a contour that is an exponential function with a base that is a function of the array waveguide index.

Although not illustrated, one or both sides of the effective area 50 of the common effective length tuner 52 illustrated in FIG. 5B can have a stair step shape. The stair step shape can encourage a consistent effective area length across the width of the array waveguide 26.

A variety of effective length tuners 28 can be employed with the array waveguide grating 24. A suitable effective length tuner 28 changes the index of refraction of the light transmitting medium 40. When the index of refraction of an array waveguides 26 increases, a longer time is required for the light signal to travel through the array waveguide 26. As a result, the array waveguide 26 is effectively longer. Alternatively, when the index of refraction of an array waveguides 26 decreases, a shorter time is required for the light signal to travel through the array waveguide 26. As a result, the array waveguide 26 is effectively shorter.

The effective length tuners 28 can be temperature control devices 54. The effective length increases as the temperature increases and the effective length decrease as the temperature decreases. Additionally, the amount of change in the effective length can be increased with increased temperatures or decreased with decreased temperatures. Further, increasing the portion of an array waveguide 26 adjacent to the temperature control device 54 increases the amount of effective length change that occurs at a particular temperature.

A suitable temperature control devices 54 can provide only heating, only cooling or both. When the temperature control device 54 provides only heating, the temperature control device 54 can be disengaged to reduce the temperature of the array waveguide 26. When the temperature control device 54 provides only cooling, the temperature control device 54 can be disengaged to increase the temperature of the array waveguide 26. The effective area 50 of a temperature control device 54 is the area of the temperature control device 54 positioned adjacent to the array waveguide 26.

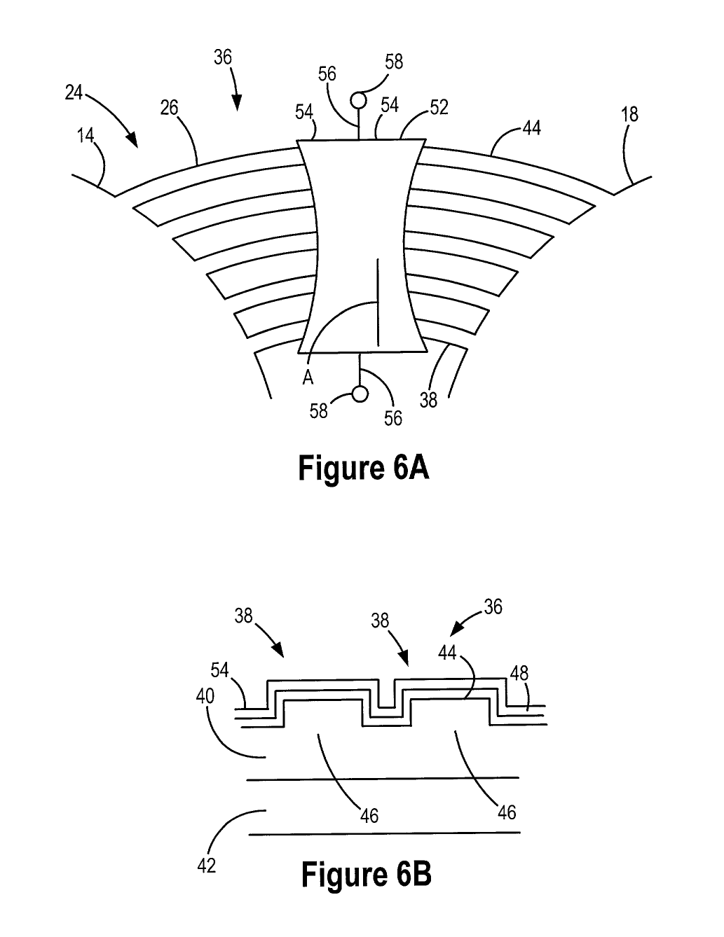

An example of a temperature control device 54 is a metal layer such as a layer of Cr, Au and NiCr. An electrical current can be flowed through the metal layer so the metal layer acts as resistive heater. FIG. 6A shows a resistive heater configured to act as a common effective length tuner 52 as discussed with respect to FIG. 5B. FIG. 6B is a cross sectional view of FIG. 6A taken at the line labeled A. The resistive heater is formed over plurality of the array waveguides 26. Electrical conductors 56 can be formed on the component 36 to deliver electrical energy to the heater. The electrical conductors 56 are in communication with pads 58 that can be connected to the controller 30 by wires. The resistive heater is configured so the temperature is substantially even across the surface. As a result, the amount of effective length change is about the same per unit of effective area 50 for each resistive heater.

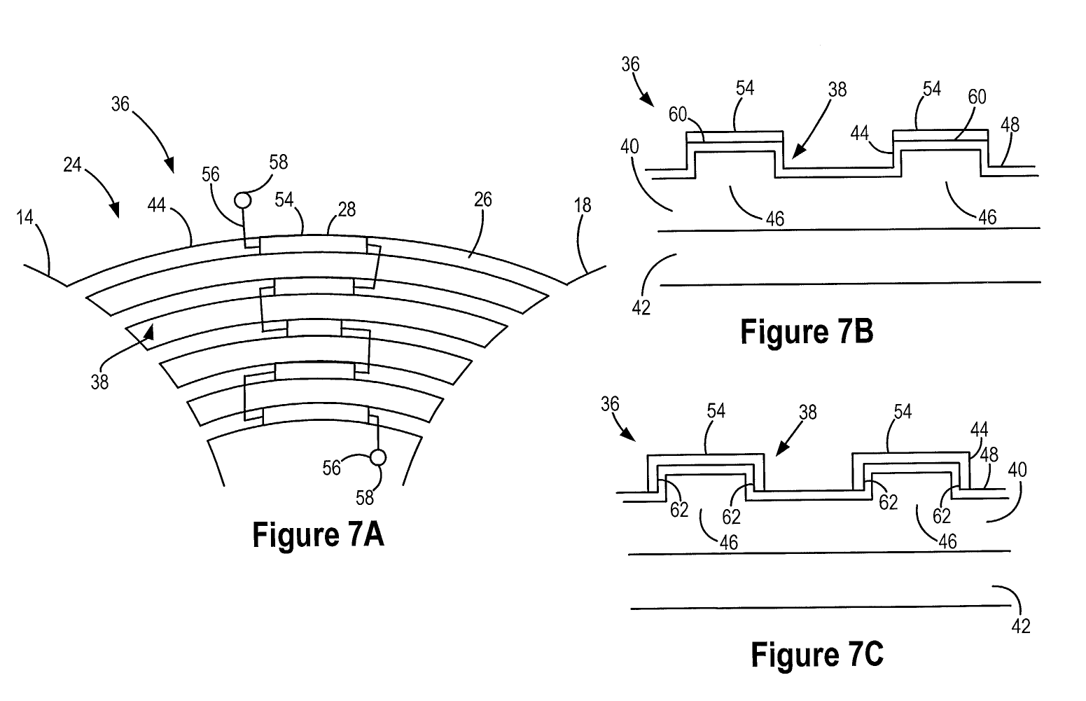

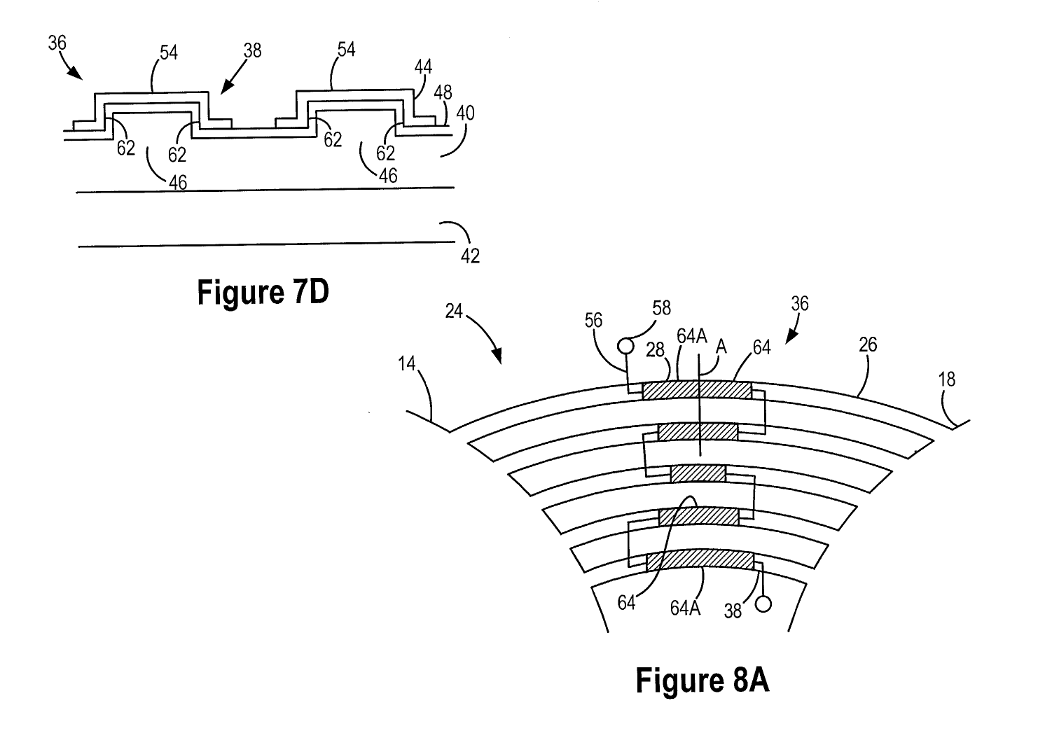

Another suitable arrangement of electrical heaters is illustrated in FIG. 7A. A resistive heater is positioned over the top 60 of the ridge 44 of each array waveguide 26. Each resistive heater can extend across the width of the ridge 44 as shown in FIG. 7B. Although the resistive heater need not extend across the entire width of the ridge 44, extending the resistive heater across the width of the ridge 44 helps preserve the uniformity of change in the index of refraction across the width of the array waveguide 26.

The resistive heater can be positioned adjacent to the sides 62 of the ridge 44 as shown in FIG. 7C in order to increase the portion of the light signal carrying region 46 exposed to the temperature change. Further, the resistive heater can extend away from the sides 62 of the ridge 44 as shown in FIG. 7D. Extending the resistive heater away from the sides 62 of the ridge 44 further increases the portion of the light signal carrying region 46 exposed to the temperature change.

FIG. 7A shows the resistive heaters connected in series by a series of electrical conductors 56. When a potential is applied between the pads 58, a current flows through the resistive heaters. Because the resistive heaters are connected in series, the same current flows through each resistive heater. When the metal layer of each resistive heater has about the same thickness and each resistive heater has the same position relative to the array waveguide 26, the degree of heating per unit of effective area 50 of the resistive heater is about the same for each resistive heater. More specifically, the temperature of each resistive heater is about the same. As a result, the amount of effective length change is about the same per unit of effective area 50 for each resistive heater.

As noted above, the degree of the effective length change increases as the temperature increases. As a result, the temperature of the resistive heaters can be controlled in order to tune the dispersion compensator 10. For instance, increasing the temperature increases the value of β.

A light transmitting medium having an increased thermal coefficient has an increased dispersion tuning range. The thermal coefficient is a function of the chosen light transmitting medium 40. For example, the thermal coefficient for Silicon is about 0.0002/° C.; polymer is about 0.00018/° C.; LiNbO₃ is about 0.000053/° C.; and silica is about 0.00001/° C.

When the temperature of the effective length tuners 28 is used to control the dispersion compensator 10, the dispersion compensator 10 can include one or more temperature sensors such as thermocouples in order provide for control of the temperature of the effective length tuners 28. Suitable locations for the temperature sensors include the top 60 or sides 62 of the ridges of the array waveguides 26, the cladding layer 48, under the effective length tuner 28 or over the effective length tuner 28. The output of the one or more temperature sensors can be monitored by the electronics 32. The electronics 32 can use the output in a feedback control loop in order to keep the effective length tuners 28 and/or the array waveguides 26 at a particular temperature.

When the effective length tuners 28 are temperature control devices 54, the dispersion compensator 10 can be controlled from calibration data. For instance, the TEC can be employed to hold the dispersion compensator 10 at a constant temperature. The value of β or the amount of dispersion tuning can be monitored as the temperature of the temperature controlled devices is changed. The generated data can then be used to determine a relationship between the temperature of the temperature control device 54 and the value of β or the amount of dispersion tuning. The relationship can be expressed by a mathematical equation generated by performing a curve fit to the data. Alternatively, the relationship can be expressed in a tabular form.

During operation of the dispersion compensator 10, the TEC is employed to hold the dispersion compensator 10 at the temperature at which the calibration data was generated. The relationship is used to identify the temperature associated with the desired dispersion. The temperature control device(s) 54 are then operated so as to achieve the desired temperature.

When the temperature control device(s) 54 are resistive heaters, calibration data can be generated using the current through the resistive heaters or the potential as an alternative to using the temperature of the temperature control devices 54. For instance, level of dispersion can be monitored as the current through the resistive heater is changed. The generated data can then be used to determine a relationship between the amount of dispersion and the current. During operation of the dispersion compensator 10, the TEC is employed to hold the dispersion compensator 10 at the temperature at which the calibration data was generated. The relationship is used to identify the current associated with the desired amount of dispersion. The temperature control device(s) 54 are then operated at the identified current or potential.

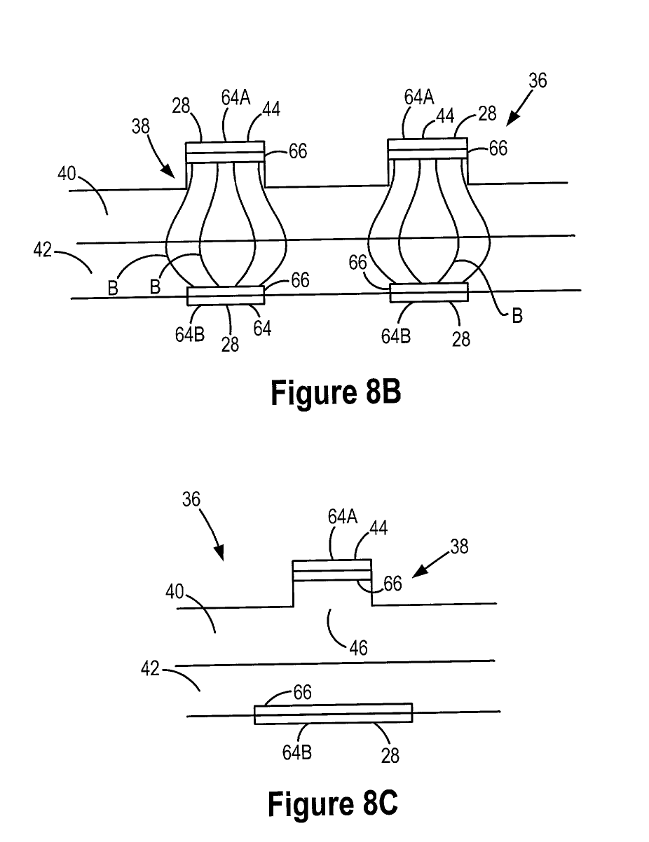

The effective length tuners 28 can also include a set of electrical contacts 64. FIG. 8A is a topview of a component 36 having effective length tuners 28 including a first electrical contact 64A and a second electrical contact 64B. FIG. 8B is a cross section of the component 36 shown in FIG. 8A taken at the line labeled A. The effective length tuners 28 include a first electrical contact 64A positioned over the ridge 44 and a second electrical contact 64B positioned under the ridge 44 on the opposite side of the component 36. A doped region 66 is formed adjacent to each of the electrical contacts 64. The doped regions 66 can be N-type material or P-type material. When one doped region 66 is an N-type material, the other doped region 66 is a P-type material. For instance, the doped region 66 adjacent to the first electrical contact 64A can be a P type material while the material adjacent to the second electrical contact 64B can be an N type material. In some instances, the regions of N type material and/or P type material are formed to a concentration of 10⁽¹⁷⁻²¹⁾/cm³ at a thickness of less than 6 μm, 4 μm, 2 μm, 1 μm or 0.5 μm. The doped region 66 can be formed by implantation or impurity diffusion techniques.

During operation of the effective length tuner, a potential is applied between the electrical contacts 64. The potential causes the index of refraction of the first light transmitting medium 40 positioned between the electrical contacts 64 to change as shown by the lines labeled B. As illustrated by the lines labeled B, the effective area 50 of each effective length tuner 28 is about equal to the portion of the first electrical contact 64A adjacent to the array waveguide 26.

When the potential on the electrical contact 64 adjacent to the P-type material is less than the potential on the electrical contact 64 adjacent to the N-type material, a current flows through the light transmitting medium 40 and the index of refraction decreases. The reduced index of refraction decreases the effective length of the array waveguides 26. When the potential on the index changing element adjacent to the P-type material is greater than the potential on the index changing element adjacent to the N-type material, an electrical field is formed between the index changing elements and the index of refraction increases. The increased index of refraction increases the effective length of the array waveguide 26. As a result, the controller 30 can change from increasing the effective length of the array waveguides 26 to decreasing the effective length of the array waveguides 26 by changing the polarity on the first electrical contact 64A and the second electrical contact 64B.

Increasing the potential applied between the electrical contacts 64 increases the amount of effective length change. For instance, when the effective length tuner 28 is being employed to increase the effective length of an array waveguide 26, increasing the potential applied between the electrical contacts 64 further increases the effective length of the array waveguide 26. Additionally, increasing the size of the first electrical contacts 64A to cover a larger area of the array waveguides 26 can increase the amount of effective length change although a larger potential may be required.

Each of the first electrical contacts 64A and the second electrical contacts 64B can be connected in series as shown in FIG. 8A. The doped regions 66 need not extend under the electrical conductor 56 connecting the electrical contacts 64. Connecting the first electrical contacts 64A in series causes the amount of current flow per unit of effective area 50 of first electrical contact 64A to be about the same for each set of electrical contacts 64. As a result, the amount of effective length change per unit of effective area 50 is about the same for each first electrical contact 64A.

As noted above, the degree of the effective length change increases as the applied potential increases. As a result, the applied potential is controlled so as to tune the dispersion compensator 10. For instance, a higher potential increases the magnitude of β.

The tuning range of effective length tuners 28 that include electrical contacts 64 can be limited by free carrier absorption that develops when higher potentials are applied between the electrical contacts 64. Free carrier absorption can cause optical loss. Increasing the value of B in Equation 12 can increase the tuning range while reducing the problems associated with free carrier absorption. Additionally, choosing a light transmitting medium 40 with an index of refraction that is highly responsive to current or electrical fields can also improve the tuning range.

The second electrical contact 64B can have about the same width as the first electrical contact 64A as shown in FIG. 8B. Alternatively, the second electrical contact 64B can have a width that is greater than the width of the first electrical contact 64A as shown in FIG. 8C. The additional width of the second electrical contact 64B can help to distribute the region where the index of refraction changes more evenly through the light signal carrying region 46.

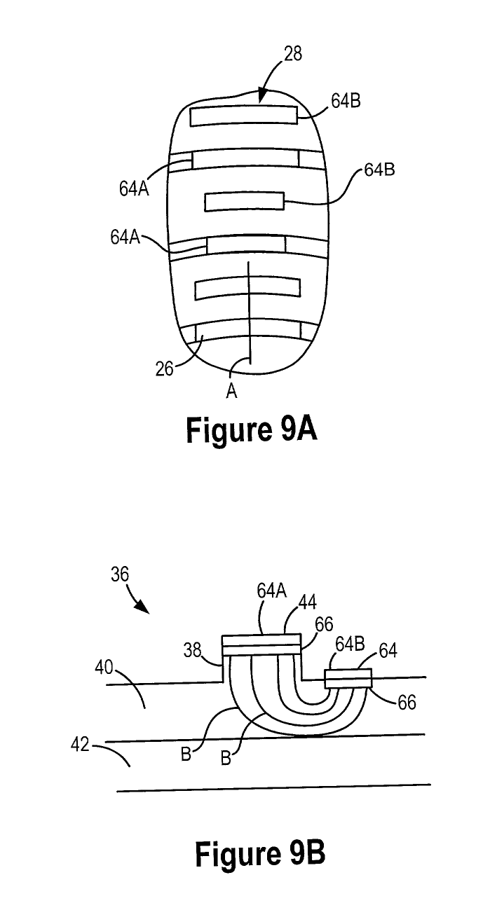

The second electrical contact 64B need not be positioned under the ridge 44 as shown in FIG. 9A through FIG. 9B. FIG. 9A is a topview of a component 36 having first electrical contact 64A positioned over the ridges 44 of the array waveguides 26 and FIG. 9B is a cross section of the component 36 of FIG. 9A taken at the line labeled A. This arrangement causes the index of refraction to be changed in the region indicated by the lines labeled B.

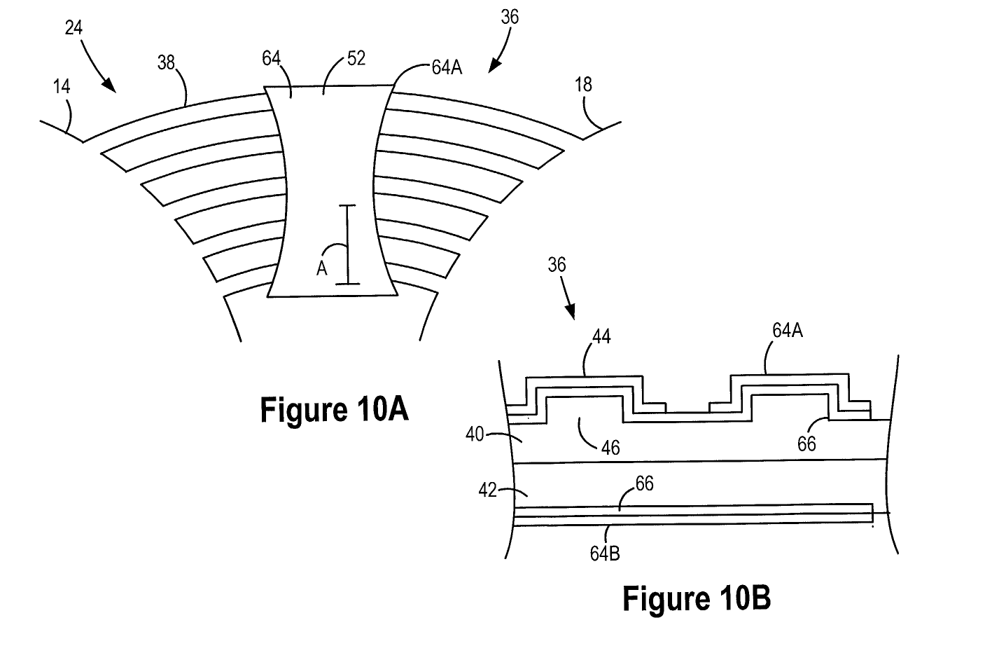

FIG. 10A and FIG. 10B show the first electrical contacts 64A and the second electrical contacts 64B integrated into a common effective length tuner 52 as discussed above in respect to FIG. 5B. FIG. 10A is a topview of a component 36 having a first electrical contact 64A extending over a plurality of the array waveguides 26 and FIG. 10B is a cross section of FIG. 10A taken at the line labeled A. Although the shape of the second electrical contact 64B is not illustrated, the second electrical contact 64B can have a shape that mirrors the shape of the first electrical contact 64A. The dimensions of the second electrical contact 64B need not be the same as the dimensions of the first electrical contact 64A. For instance, the second electrical contact 64B can have larger dimensions than the first electrical contact 64A while retaining a shape that mirrors the first electrical contact 64A. The doped regions 66 are formed under the entire first electrical contact 64A and the entire second electrical contact 64B.

The first electrical contact 64A can has a contour that is an exponential function with a base that is a function of the array waveguide index. Although not illustrated, one or both sides of the first electrical contact 64A can have a stair step shape. The stair step shape can encourage a consistent effective area length across the width of the array waveguide 26.

The electrical contacts 64 can also serve as a temperature controlled device. For instance, the doped regions 66 can be eliminated. When enough potential is applied between the electrical contacts 64, a current will flow through the light transmitting medium 40 and increase the temperature of the light transmitting medium 40. Accordingly, the electrical contacts 64 can serve as a heater.

When the effective length tuners 28 include electrical contacts 64, the dispersion compensator 10 can be controlled from calibration data. For instance, the TEC can be employed to hold the dispersion compensator 10 at a constant temperature. The amount of dispersion change is monitored as the potential on the electrical contacts 64 is changed. The generated data is used to determine a relationship between the amount of dispersion change and the applied potential. The relationship can be expressed by a mathematical equation generated by performing a curve fit to the data. Alternatively, the relationship can be expressed in a tabular form.

During operation of the dispersion compensator 10, the TEC is employed to hold the dispersion compensator 10 at the temperature at which the calibration data was generated. The relationship is used to identify the potential associated with the wavelength that is desired to appear on the output waveguide 16. The effective length tuners 28 are then operated at the desired potential.

The effective length tuners 28 need not be constructed to produce a change in effective length per unit of effective area 50 that is about the same for each effective length tuner 28. For instance, the controller 30 can independently control each effective length tuner 28. The controller 30 can control the effective length tuners 28 so different effective length tuners 28 have a different change in effective length per unit of effective area 50. For instance, when the effective length tuners 28 are temperature controlled devices the controller 30 can control the effective length tuners 28 so different effective length tuners 28 have different temperatures. As a result, each effective length tuner 28 can have about the same effective area 50 but the effective length tuners are operated so as to retain the relationships in Equation 1.

When the effective length tuners 28 include sets of electrical contacts 64, the controller 30 can control the effective length tuners 28 so a different amount of current flows through different effective length tuners 28. As a result, each effective length tuner 28 can have about the same effective area 50 but the effective length tuners are operated so as to retain the relationships in Equation 1.

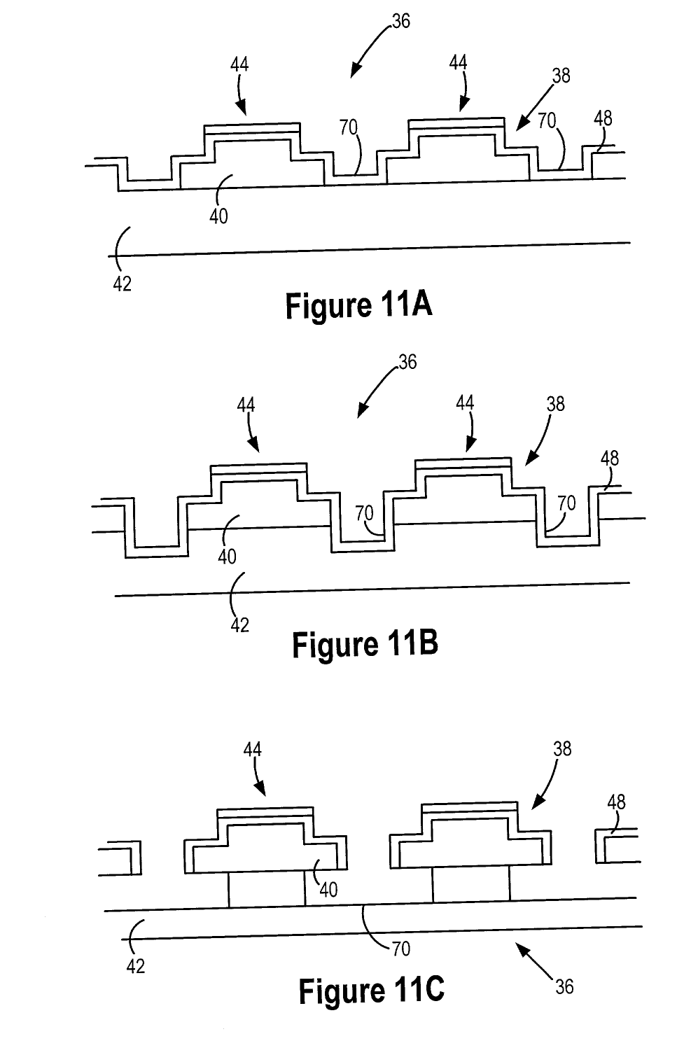

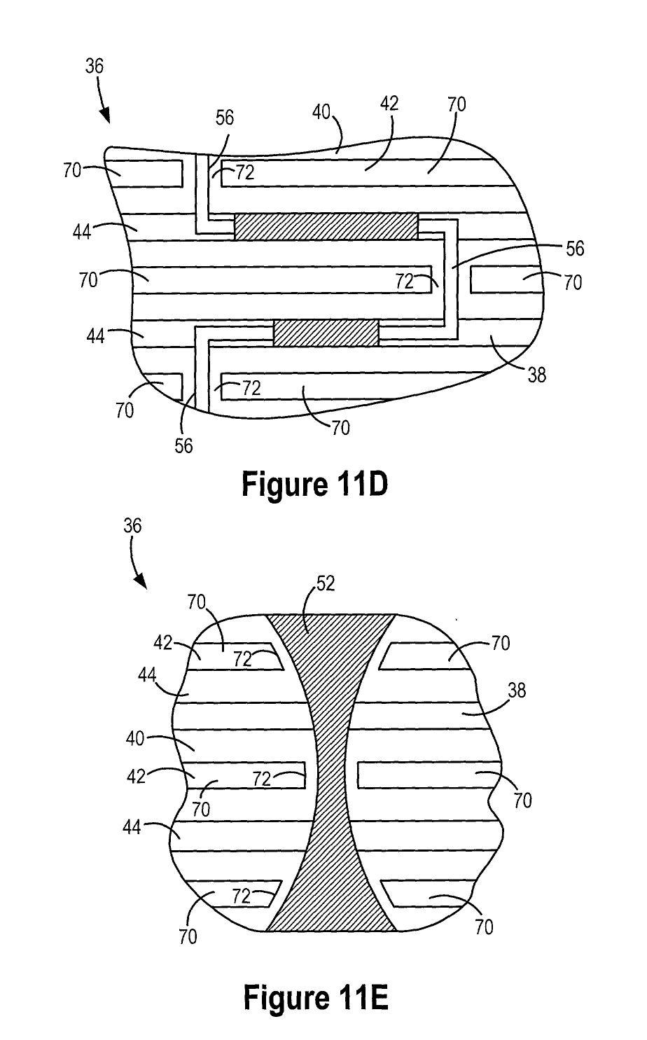

FIG. 11A through FIG. 11E illustrate component 36 constructions that can increase isolation of adjacent array waveguides 26. This isolation is often desired due to the close proximity of the array waveguides 26. The close proximity can permit the electrical or thermal effects in one array waveguide 26 to influence the performance of adjacent array waveguides 26. The close proximity can permit the electrical or thermal effects in one array waveguide 26 to influence the performance of adjacent array waveguides 26 and can also reduce the power consumption. For instance, when thermal energy flows freely through the light transmitting medium 40, temperature changes to one array waveguide 26 can flow through the light transmitting medium 40 and affect the temperature of adjacent array waveguides 26. Silicon has a thermal conductivity is about 1.5 W/cm*° C. while silica has a thermal conductivity of about 0.014 W/cm*° C. Accordingly, thermal energy flows more freely through silicon than it does through silica.

FIG. 11A illustrates array waveguides 26 having an isolation groove 70 positioned between adjacent array waveguides 26. The isolation groove 70 extends through the light transmitting medium 40 to the base 42. The isolation groove 70 effectively increases the distance that thermal or electrical energy must travel from one array waveguide 26 in order to affect another array waveguide 26. Although the isolation groove 70 is illustrated as extending through the light transmitting medium 40, the isolation groove 70 can extend only part way through the light transmitting medium 40.

FIG. 11B illustrate an embodiment of array waveguides 26 having an isolation groove 70 extends through the light transmitting medium 40 and into the base 42. As a result, the length of the path available for energy to travel between array waveguides 26 is further increased above the path length of the embodiment shown in FIG. 11A. Increasing this path length increase the degree of isolation between the array waveguides 26.

FIG. 11C illustrate another embodiment of array waveguides 26 having an isolation groove 70 extends through the light transmitting medium 40 and into the base 42. The isolation groove 70 undercuts the light transmitting medium 40. The undercut reduces the size of the path that is available for thermal or electrical energy to travel from one array waveguide 26 into another array waveguide 26 from the size of the available path in FIG. 11B.

FIG. 11D is a topview of the components 36 shown in FIGS. 11A through 11C when each array waveguide 26 includes an effective length tuner 28. A bridge region 72 bridges the isolation groove 70 between adjacent array waveguides 26. The electrical conductor 56 is formed on the bridge region 72. Accordingly, the bridge region 72 prevents the need to form the electrical conductor 56 in the isolation groove 70. FIG. 11E is a topview of the component 36 shown in FIG. 11A through FIG. 11C when the effective length tuners 28 are incorporated into a common effective length tuner 52 positioned adjacent to more than one array waveguide 26. The bridge region 72 is constructed so as to support a wedge shaped common effective length tuner 52.

The bridge region 72 can be eliminated when electrical conductors 56 do not need to be formed between adjacent array waveguides 26. For instance, when the effective length tuners 28 are independently controlled the electrical conductors 56 can directly connect each effective length tuner 28 to the controller 30. As a result, there is no need for electrical conductors 56 to connect adjacent effective length tuners 28 and the bridge region 72 can be eliminated.

The isolation grooves can also reduce the amount of cross talk associated with the component. A common source of cross talk is light signals exiting the light signal carrying region of one waveguide and entering another waveguide. Positioning the isolation grooves between waveguides can prevent the light signals from entering other waveguides.

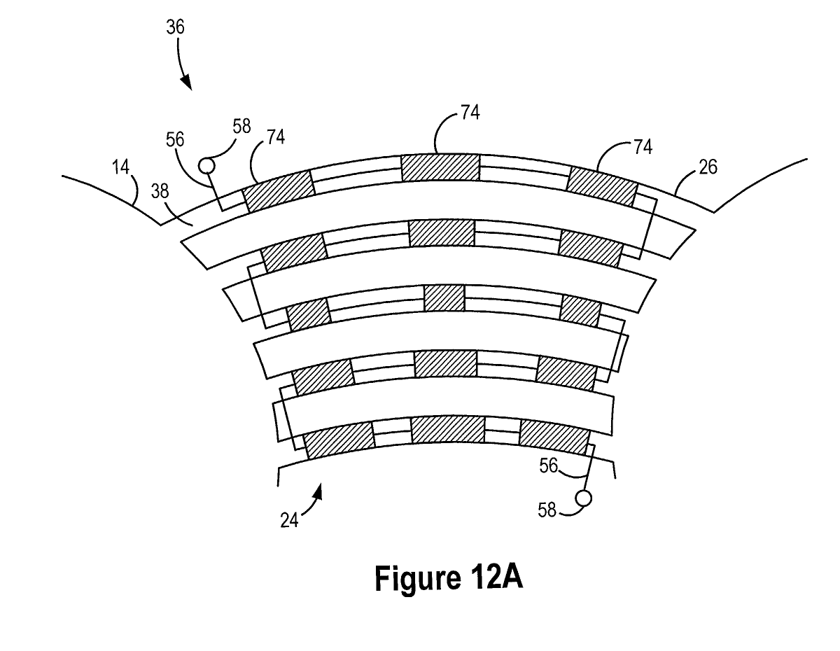

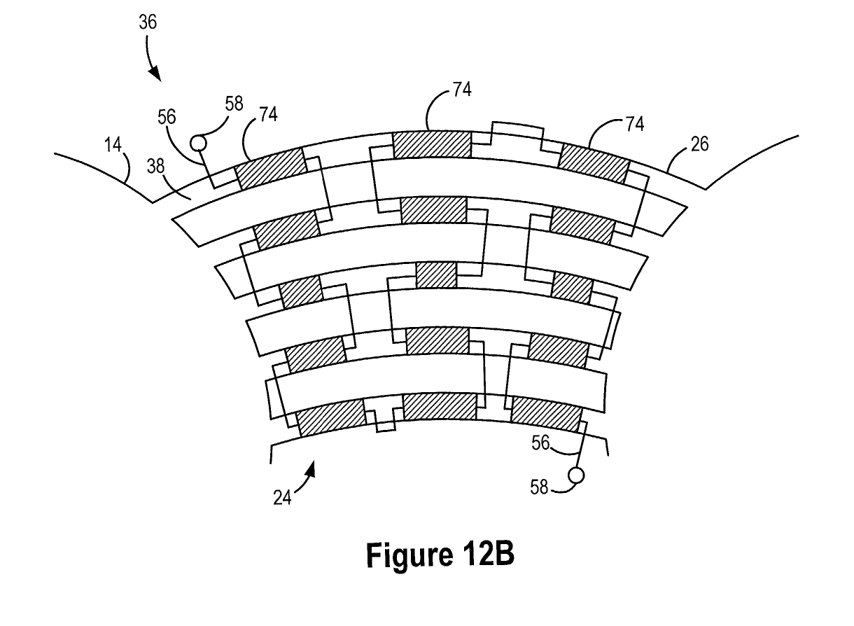

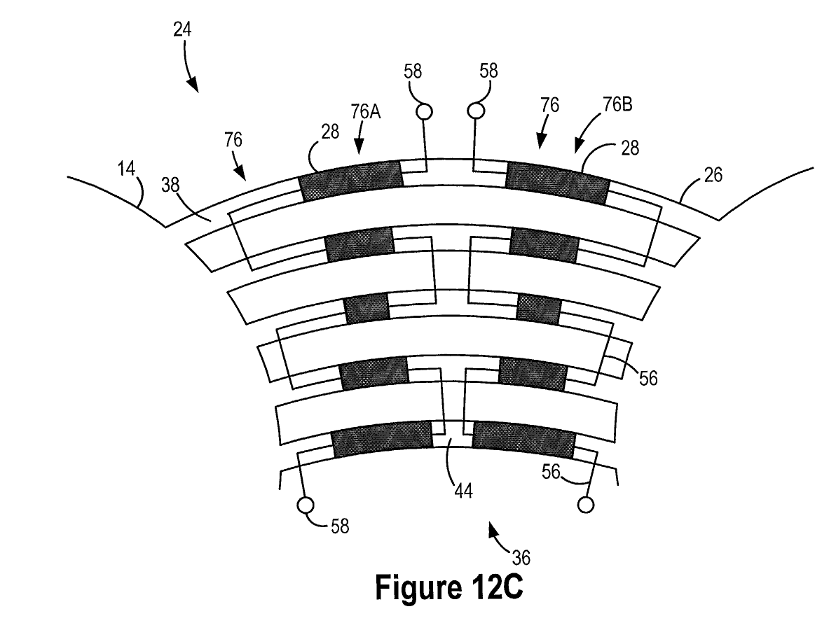

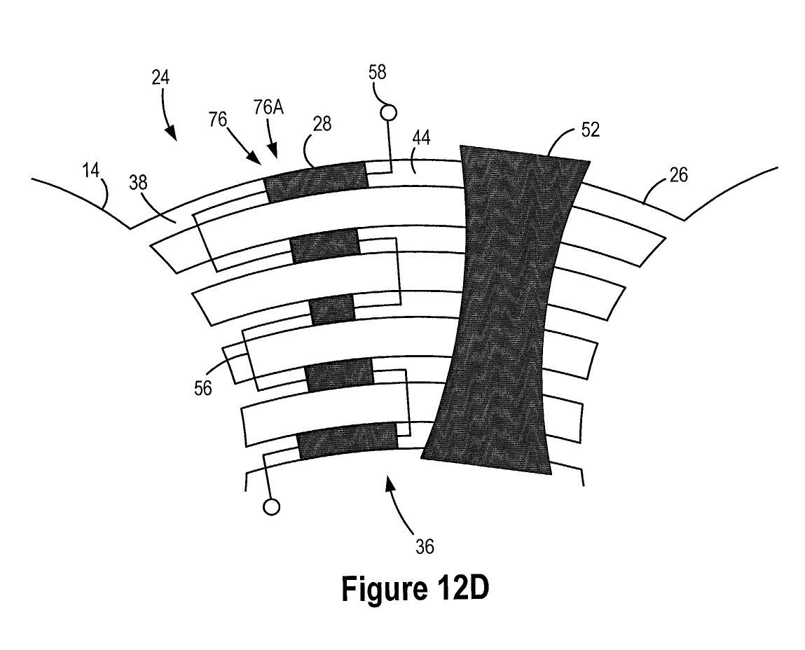

An effective length tuner 28 can be broken into a plurality of sub-effective length tuners 74 as shown in FIG. 12A. The electrical conductors 56 connect the sub-effective length tuners 74 in series. Breaking the effective length tuners 28 into smaller portions can increase the isolation between adjacent array waveguides 26 because each sub-effective length tuner 74 affects a smaller region of the component 36 that does an effective length tuner 28. Although each of the array waveguide 26 is shown as having the same number of sub-effective length tuners 74, different array waveguides 26 can have different numbers of effective length tuners 28. For instance, the shortest waveguide 38 can have a single sub-effective length tuner 74.

FIG. 12B illustrates another embodiment of the sub effective length tuners connected in series. The sub effective length tuners each connect sub effective length tuners on adjacent array waveguides. This arrangement can provide an improved thermal or electrical uniformity across the lengths of the array waveguides.

The array waveguides 26 can each include more than one effective length tuner 28 as shown in FIG. 12C. The effective length tuners 28 are operated in groups 76. For instance, the effective length tuners 28 of a first group 76A are connected in series and the effective length tuners 28 of a second group 76B are connected in series. The groups 76 can be operated independently of one another. For instance, the effective length tuners 28 of the first group 76A can be operated while the effective length tuners 28 of the second group 76B remain dormant. Once the effective length tuners 28 of the first group 76A do not provide sufficient tuning range, the effective length tuners 28 of the second group 76B can be operated so as to provide additional tuning range. This method of operation can reduce the power requirements of the dispersion compensator 10. Further, the effective length tuners can be configured such that different groups have different tuning ranges. For example, an effective length tuner 28 from the first group 76A and an effective length tuner 28 from the second group 76B positioned on the same array waveguide can have different effective area lengths. The group that is employed during tuning can be the group that has the desired tuning range or both groups can be operated together.

When an array waveguides include more than one effective length tuner, the array waveguides can include more than one type of effective length tuner 28. For instance, FIG. 12D illustrates an array waveguide grating 24 having a first group 76A of effective length tuners 28 and a second group of effective length tuners integrated into a common effective length tuner. The common effective length tuner can include electrical contacts or a temperature control device. The first group 76A and the second group 76B can be operated independently or in conjunction so as to optimize the performance of the dispersion compensator 10. For instance, the second group 76B can be operated until the effects of free carrier absorption are evident. The first group 76A can then be engaged to provide additional tuning range.

When the array waveguide grating includes a plurality of effective length tuner groups, the effective length tuner groups can be configured to tune different orders of dispersion. For instance, one effective length tuner group can be configured to tune dispersion while another effective length tuner group can be configured to tune dispersion slope.

Although not illustrated, the effective length tuners 28 can include a temperature control device 54 positioned over an electrical contact 64. This arrangement can provide an increased tuning range over what could be achieved with either type of effective length tuner 28 alone. When the temperature controlled device is a resistive heater, an electrical insulator can be positioned between the electrical contact 64 and the resistive heater.

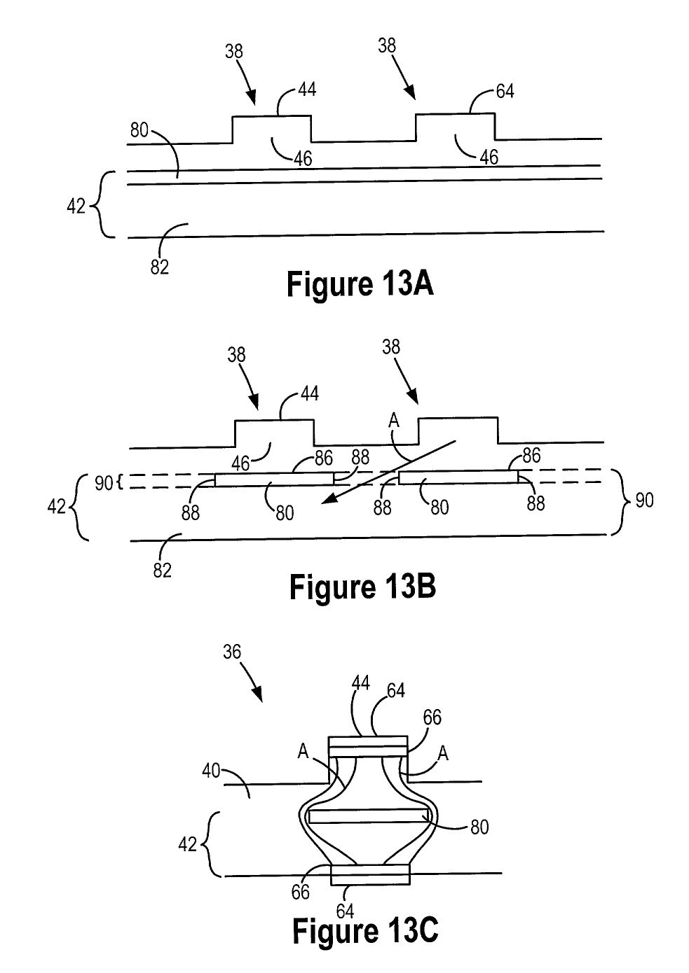

The base 42 can have a variety of constructions. FIG. 13A illustrates a component 36 having a base 42 with a light barrier 80 positioned over a substrate 82. The light barrier 80 serves to reflect the light signals from the light signal carrying region 46 back into the light signal carrying region 46. Suitable light barriers 80 include material having reflective properties such as metals. Alternatively, the light barrier 80 can be a material with a smaller index of refraction than the light transmitting medium 40. The change in the index of refraction can cause the reflection of light from the light signal carrying region 46 back into the light signal carrying region 46. A suitable light barrier 80 would be silica when the light carrying medium and the substrate 82 are silicon. Another suitable light barrier 80 would be air or another gas when the light carrying medium is silica and the substrate 82 is silicon. A suitable substrate 82 includes, but is not limited to, a silicon substrate 82.

The light barrier 80 need not extend over the entire substrate 82 as shown in FIG. 13B. For instance, the light barrier 80 can be an air filled pocket formed in the substrate 82. The pocket 84 can extend alongside the light signal carrying region 46 so as to define a portion of the light signal carrying region 46.

In some instances, the light signal carrying region 46 is adjacent to a surface 86 of the light barrier 80 and the light transmitting medium 40 is positioned adjacent to at least one side 88 of the light barrier 80. As a result, light signals that exit the light signal carrying region 46 can be drained from the waveguide 38 as shown by the arrow labeled A. These light signals are less likely to enter adjacent array waveguide 26. Accordingly, these light signals are not a significant source of cross talk.

The drain effect can also be achieved by placing a second light transmitting medium 90 adjacent to the sides 88 of the light barrier 80 as indicated by the region below the level of the top dashed line or by the region located between the dashed lines. The drain effect is best achieved when the second light transmitting medium 90 has an index of refraction that is greater than or substantially equal to the index of refraction of the light transmitting medium 40 positioned over the base 42. In some instances, the bottom of the substrate 82 can include an anti reflective coating that allows the light signals that are drained from a waveguide 38 to exit the component 36.

When the component 36 includes isolation grooves 70, the isolation grooves 70 can be spaced apart from the sides 88 of the light barrier 80. For instance, the second light transmitting medium 90 can be positioned between a side 88 of the light barrier 80 and the isolation groove 70.

The input waveguide 12, the array waveguides 26 and/or the output waveguide 16 can be formed over a light barrier 80 having sides 88 adjacent to a second light transmitting medium 90.

The drain effect can play an important role in improving the performance of the dispersion compensator 10 because there are a large number of waveguides 38 formed in close proximity to one another. The proximity of the waveguides 38 tends to increase the portion of light signals that act as a source of cross talk by exiting one waveguide 38 and entering another. The drain effect can reduce this source of cross talk.

Other base 42 and component 36 constructions suitable for use with a dispersion compensator 10 according to the present invention are discussed in U.S. patent application Ser. No. 09/686,733, filed on Oct. 10, 2000, entitled “Waveguide Having a Light Drain” and U.S. patent application Ser. No. (not yet assigned), filed on Feb. 15, 2001, entitled “Component Having Reduced Cross Talk” each of which is incorporated herein in its entirety.

The construction of the base 42 can affect the performance and/or the selection of the effective length tuner 28. For instance, electrical current does not readily flow through air. As a result, when the light barrier 80 is constructed from air and the base 42 is constructed as shown in FIG. 13B, the change in the index of refraction appears as shown by the lines labeled A in FIG. 13C.

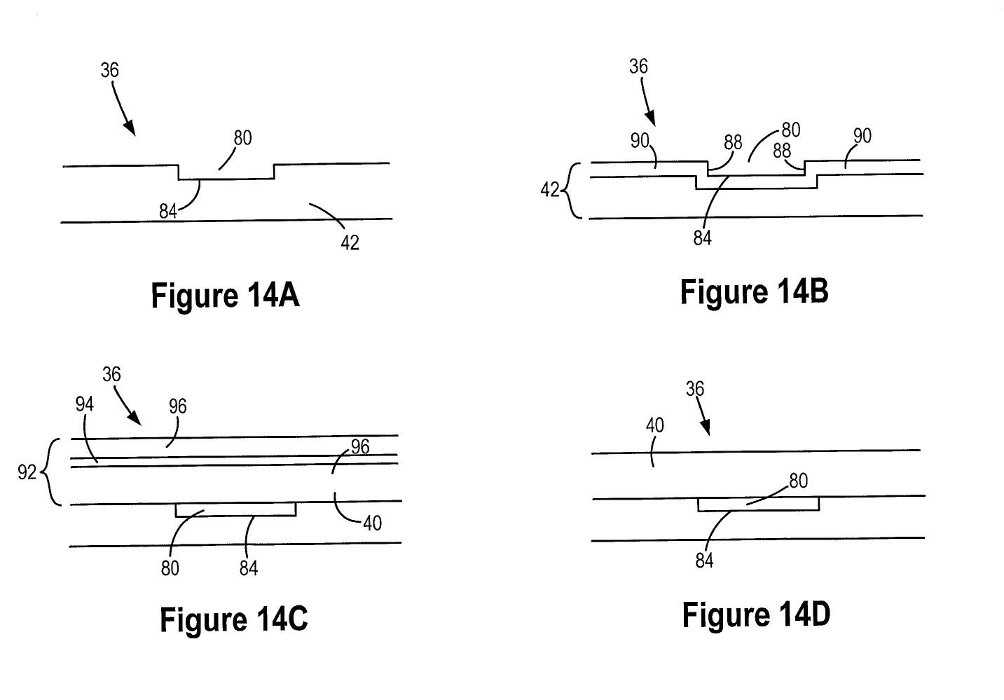

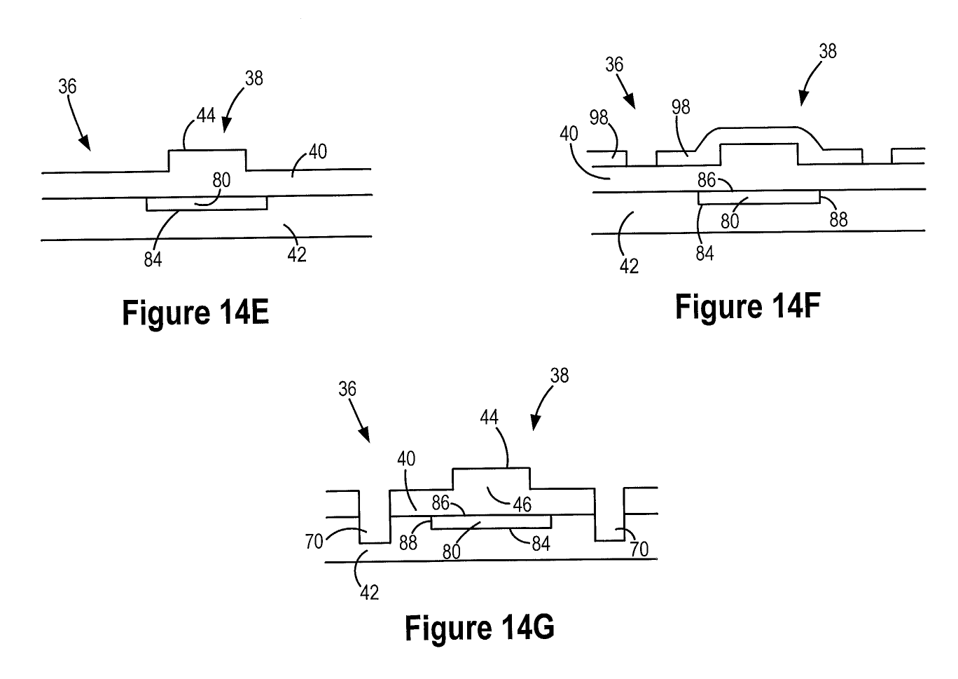

FIG. 14A to FIG. 14G illustrate a method for forming a component 36 having a dispersion compensator 10. A mask is formed on a base 42 so the portions of the base 42 where a light barrier 80 is to be formed remain exposed. A suitable base 42 includes, but is not limited to, a silicon substrate. An etch is performed on the masked base 42 to form pockets 84 in the base 42. The pockets 84 are generally formed to the desired thickness of the light barrier 80.

Air can be left in the pockets 84 to serve as the light barrier 80. Alternatively, a light barrier 80 material such as silica or a low K material can be grown or deposited in the pockets 84. The mask is then removed to provide the component 36 illustrated in FIG. 14A.

When air is left in the pocket 84, a second light transmitting medium 90 can optionally be deposited or grown over the base 42 as illustrated in FIG. 14B. When air will remain in the pocket 84 to serve as the light barrier 80, the second light transmitting medium 90 is deposited so the second light transmitting medium 90 is positioned adjacent to the sides 88 of the light barrier 80. Alternatively, a light barrier 80 material such as silica can optionally be deposited in the pocket 84 after the second light transmitting medium 90 is deposited or grown.

The remainder of the method is disclosed presuming that the second light transmitting medium 90 is not deposited or grown in the pocket 84 and that air will remain in the pocket 84 to serve as the light barrier 80. A light transmitting medium 40 is formed over the base 42. A suitable technique for forming the light transmitting medium 40 over the base 42 includes, but is not limited to, employing wafer bonding techniques to bond the light transmitting medium 40 to the base 42. A suitable wafer for bonding to the base 42 includes, but is not limited to, a silicon wafer or a silicon on insulator wafer 92.

A silicon on insulator wafer 92 includes a silica layer 94 positioned between silicon layers 96 as shown in FIG. 14C. The top silicon layer 96 and the silica layer 94 can be removed to provide the component 36 shown in FIG. 14D. Suitable methods for removing the top silicon layer 96 and the silica layer 94 include, but are not limited to, etching and polishing. The bottom silicon layer 96 remains as the light transmitting medium 40 where the waveguides 38 will be formed. When a silicon wafer is bonded to the base 42, the silicon wafer will serve as the light transmitting medium 40. A portion of the silicon layer 96 can be removed from the top and moving toward the base 42 in order to obtain a light transmitting medium 40 with the desired thickness.

A silicon on insulator wafer can be substituted for the component illustrated in FIG. 14D. The silicon on insulator wafer preferably has a top silicon layer with a thickness that matches the desired thickness of the light transmitting medium. The remainder of the method is performed using the silicon on insulator wafer in order to create an optical component having the base shown in FIG. 13A.

The light transmitting medium 40 is masked such that places where a ridge 44 is to be formed are protected. The component 36 is then etched to a depth that provides the component 36 with ridges 44 of the desired height as shown in FIG. 14E.

When the component 36 is to include isolation trenches, a mask 98 is formed on the component 36 so the regions where isolation trenches are to be formed remain exposed as shown in FIG. 14F. An etch is then performed to the desired depth of the isolation trenches. The mask 98 is then removed to provide the component 36 illustrated in FIG. 14G. When the light transmitting medium 40 is to be undercut as shown in FIG. 1 IC, an anisotropic etch can be performed so as to form the undercut. The anisotropic etch can be performed before the mask shown in FIG. 14F is removed.

As shown in FIG. 1B, the dispersion compensator 10 can be constructed such that the array waveguides 26 include a reflector 34. A suitable method for forming a reflector 34 is taught in U.S. patent application Ser. No. 09/723,757, filed on Nov. 28, 2000, entitled “Formation of a Reflecting surface on an Optical Component” and incorporated herein in its entirety.

When the component 36 will include a cladding 48, the cladding 48 can be formed at different places in the method. For instance, the cladding 48 can be deposited or grown on the component 36 of FIG. 14E. Alternatively, the cladding 48 can be deposited or grown on the component 36 of FIG. 14G.

Any doped regions 66 to be formed on the ridge 44, adjacent to the ridge 44 and/or under the ridge 44 can be formed using techniques such as impurity deposition, implantation or impurity diffusion. The electrical contacts 64 can be formed adjacent to the doped regions 66 by depositing a metal layer adjacent to the doped regions 66. Any metal layers to be used as temperature control devices 54 can be grown or deposited on the component 36. Doped regions 66, electrical contact 64,, electrical conductors 56, pads 58 and/or metal layers can be formed at various points throughout the method and are not necessarily done after the last etch. Suitable electrical conductors 56 and pads 58 include, but are not limited to, metal traces.

The etch(es) employed in the method described above can result in formation of a facet and/or in formation of the sides 62 of a ridge of a waveguide 38. These surfaces are preferably smooth in order to reduce optical losses. Suitable etches for forming these surfaces include, but are not limited to, reactive ion etches, the Bosch process and the methods taught in U.S. patent application Ser. No. (not yet assigned); filed on Oct. 16, 2000; and entitled “Formation of a Smooth Vertical Surface on an Optical Component” which is incorporated herein in its entirety.

All of the array waveguides 26 need not include an effective length tuner 28. As noted above, the exponential function can be centered on particular array waveguide(s). The particular array waveguide(s) on which the exponential function is centered need not include an effective length tuner.

In the embodiments illustrated above, the effective length tuners 28 are shown as being positioned adjacent to a portion of the length of the array waveguides 26, however, the effective length tuners 28 can be positioned adjacent to the entire length of one or more of the array waveguides 26. Additionally, the effective length tuners 28 need not have an effective area positioned adjacent to the input light distribution component 14 and/or the output light distribution component 18. As a result, the effective length tuners 28 need not change the optical characteristics of the input light distribution component 14 and/or the output light distribution component 18.

Many of the effective length tuners 28 are shown as being positioned adjacent to a curved region of an array waveguide 26. However, each array waveguide 26 can include one or more straight sections and the effective length tuners 28 can be positioned along these straight sections.

Many of the array waveguide gratings 24 above are illustrated as having six or fewer array waveguides 26 for the purposes of illustration. Array waveguide gratings 24 according to the invention can include tens to hundreds of array waveguides 26.

Although the invention is disclosed in the context of optical components having ridge waveguides, the principles of the invention can be extended to optical components that include other waveguide types such as buried channel waveguides, strip waveguides and diffused waveguides.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

What is claimed is:

1. A dispersion compensator, comprising:
an array waveguide grating having a plurality of array waveguides that each have an effective length;
a component configured to receive portions of a light signal from the array waveguide grating and combine portions of the light signal into an output light signal having a dispersion profile; and
at least a portion of the array waveguides including effective length tuners for tuning the effective lengths of the array waveguides such that the dispersion profile of the output light signal is tuned.

2. The compensator of claim 1, wherein each effective length is configured to change the temperature of an array waveguide.

3. The compensator of claim 1, wherein each effective length tuner is configured to drive a current through an array waveguide.

4. The compensator of claim 1, wherein the effective length tuners are integrated into a common effective length tuner positioned adjacent to a plurality of the array waveguides.

5. The compensator of claim 1, wherein the array waveguides are associated with an array waveguide index j, and the effective length tuners are configured to be tuned such that the amount of the effective length change for the array waveguides is an exponential function with a base that is a function of the array waveguide index.

6. The compensator of claim 5, wherein the exponential function includes:
β(j+C)^{α}
C and α being constants and β having a value that changes in response to tuning of the effective length tuners.

7. The compensator of claim 6, wherein α is about 2.

8. The compensator of claim 6, wherein α is greater than 2.

9. The compensator of claim 1, wherein the array waveguides are associated with an array waveguide index j, and further comprising:
electronics for tuning the effective length tuners such that the amount of the effective length change for the array waveguides is an exponential function with a base that is a function of the array waveguide index.

10. The compensator of claim 9, wherein the exponential function includes:
β(j+C)^{α}
C and α being constants and β having a value that changes in response to tuning of the effective length tuners.

11. The compensator of claim 10, wherein α is about 2.

12. The compensator of claim 10, wherein α is greater than 2.

13. The compensator of claim 1, wherein the array waveguides are associated with an array waveguide index j, and
the effective length tuners have an effective area length extending along a length of an array waveguide, the effective area lengths being an exponential function with a base that is a function of the array waveguide index.

14. The compensator of claim 13, wherein the exponential function includes:
B(j+C)^{α}
wherein B, C and α are constants.

15. The compensator of claim 1, wherein the component has an input side and an output side, the array waveguide grating being connected to the input side and the array waveguides have lengths selected such that light signals of different wavelengths are incident on different regions of the output side.

16. The compensator of claim 1, wherein the component has an input side and an output side, the array waveguide grating being connected to the input side and the array waveguides have lengths selected such that light signals of different wavelengths are each incident on a region of the output side.

17. The compensator of claim 1, wherein the component has an input side and an output side, the array waveguide grating being connected to the input side and the array waveguides have lengths selected such that a dispersion profile of the input light signal is different than the dispersion profile of the output light signal.

18. The compensator of claim 1, wherein the array waveguides are associated with an array waveguide index j, and the lengths of the array waveguides including one or more exponential functions having a base that is a function of the array waveguide index j.

19. The compensator of claim 18, wherein the exponential function includes:
δ(j+C)^{ε}
where C, δ and ε have a constant value.

20. A dispersion compensator, comprising:
an array waveguide grating including a plurality of array waveguides having an effective length and being configured to receive a portion of an input light signal;
at least a portion of the array waveguides having effective length tuners for tuning the effective lengths of the array waveguides; and
an output waveguide configured to receive at least a portion of the input light signal portions, the received input light signal portions being combined into an output light signal having an output dispersion profile, the output dispersion profile changing in response to tuning of the effective length tuners.

21. The compensator of claim 20, wherein each effective length tuner includes a device for changing the temperature of an array waveguide.

22. The compensator of claim 20, wherein the effective length tuners are configured to drive a current through an array waveguide.

23. The compensator of claim 20, wherein the effective length tuners are integrated into a common effective length tuner positioned adjacent to a plurality of the array waveguides.

24. The compensator of claim 20, wherein the array waveguides are associated with an array waveguide index j, and the effective length tuners are configured to be tuned such that the amount of the effective length change for the array waveguides is an exponential function with a base that is a function of the array waveguide index.

25. The compensator of claim 20, wherein the array waveguides are associated with an array waveguide index j, and further comprising:
electronics for tuning the array waveguides such that the amount of the effective length change for the array waveguides is an exponential function with a base that is a function of the array waveguide index.

26. The compensator of claim 20, wherein the number of array waveguides is equal to N and the array waveguides are associated with an array waveguide index j where j=1 through N; and
the effective length tuners each have an effective area length extending along a length of an array waveguide, the effective area lengths being an exponential function with a base that is a function of the array waveguide index.

27. The compensator of claim 20, wherein the output waveguide is one of a plurality of output waveguides and the array waveguides having lengths selected such that different output waveguides receive portions of the input light signals having different wavelengths.

28. The compensator of claim 20, wherein the array waveguides have lengths selected such that the output waveguide receives portions of the input light signals having different wavelengths.

29. The compensator of claim 20, wherein the array waveguides are associated with an array waveguide index j, and the length of the array waveguides includes one or more exponential functions having a base that is a function of the array waveguide index j.

30. A dispersion compensator, comprising:
an array waveguide grating having a plurality of array waveguides that each have an effective length, the array waveguides being configured to carry portions of an input light signal;
a component configured to receive the portions of the input light signal from the array waveguide grating and to combine the portions of an input light signal into an output light signal having a dispersion profile;
at least a portion of the array waveguides including effective length tuners for tuning the effective lengths of the array waveguides; and
electronics for tuning the effective length tuners such that the dispersion profile of the output light signal changes.

31. The compensator of claim 30, wherein the array waveguides are associated with an array waveguide index j, and the electronics are configured to tune the effective length tuners such that the amount of the effective length change for an array waveguide is an exponential function with a base that is a function of the array waveguide index.

32. The compensator of claim 31, wherein the exponential function includes:
β(j+C)^{α}
C and α being constants and β having a value that changes in response to tuning of the effective length tuners.

33. The compensator of claim 32, wherein α is about 2.

34. The compensator of claim 32, wherein α is greater than 2.

35. A method of tuning the dispersion profile of a light signal, comprising:
combining portions of a light signal that exit an array waveguide grating into an output light signal having a dispersion profile, at least a portion of the array waveguides having a tunable effective length; and
tuning the effective length of the array waveguides such that the dispersion profile changes.

36. The method of claim 35, wherein the array waveguides are associated with an array waveguide index, j, and the effective length of the array waveguides are tuned such that an amount of effective length change for an array waveguide is an exponential function with a base that is a function of the array waveguide index.

37. The method of claim 36, wherein the exponential function includes β(j+C)^{α}, C and α being constants and β having a value that changes in response to tuning of the effective length tuners.

38. The method of claim 37, wherein α is about 2.

39. The method of claim 37, wherein α is greater than 2.

40. The method of claim 37, wherein C is a function of the total number of array waveguides.
